(19) United States
(12) Patent Application Publication
(10) Pub. No.: US 2012/0066727 A1
(43) Pub. Date: Mar. 15, 2012

(54) TRANSMITTING APPARATUS AND RECEIVING APPARATUS

(76) Inventors: Takahiko NOZOE, Yokohama (JP); Mikine Ishiguro, Chigasaki (JP)

(21) Appl. No.: 13/219,024

(22) Filed: Aug. 26, 2011

(30) Foreign Application Priority Data
Sep. 15, 2010 (JP) 2010-206238
Sep. 15, 2010 (JP) 2010-206239

(51) Int. Cl. H04N 21/235; H04N 21/435

(52) U.S. Cl. 725/88; 725/93; 725/100

(57) ABSTRACT

A transmitting apparatus comprises, a playback portion, which is configured to playback content; a content transmitting portion, which is configured to transmit the content through a network; and a controlling portion, which is configured to hold chapter information for indicating separation of a scene of the content, and to transmit the chapter information held therein through the network, wherein the controlling portion renews the chapter information held therein, when producing the chapter information, and when obtaining the chapter information, which is generated in other apparatus differing from the transmitting apparatus, through the network.

This application relates to and claims priority from Japanese Patent Applications Nos. 2010-206238 and 2010-206239, both being filed on Sep. 15, 2010, the entire disclosures of which are incorporated herein by references.

### BACKGROUND OF THE INVENTION

The technical field relates to an apparatus for transmitting or receiving contents through a network.

In relation to the technical field mentioned above, in the following Patent Document 1 is described “to provide a playback apparatus for enabling a user to view/listen the contents stored within plural numbers of AV devices, which are connected with a network, easily, by a unit of packet, with referring thereto, appropriately”, as a problem to be dissolved, and as the dissolving means thereof is described “a playback apparatus having a communicating portion 11 for conducting communication with devices on a network, a playback portion 22 for decoding and playing back contents by a unit of packet, and a controlling portion for conducting such a control that it obtains management information (VR_MANGR. IFO) of contents stored in the devices on the network by controlling the communicating portion, so as to display the contents upon basis of the management information, and responding thereto, it receives a playback instruction from a user, for obtaining the contents on the devices through the communicating portion responding to the playback instruction, by the unit of packet, and thereby playing back the packet of the contents obtained in the reproducing portion.”

Also, in the following Patent Document 2 is described “to provide a home network AV server and a home network server program, being superior in usability thereof, for enabling to reopen the viewing/listing, easily, from an interrupted position, even if stopping the viewing/listing of contents”, as the problem to be dissolved, and as the dissolving means thereof is described “a home network AV server comprising an AV content data group memory portion 111, a content information list memory portion 112, a transmission data producing portion 116 for producing content data responding to transmission requests from client terminals 21 and 22, which are connected through a network, thereby transmitting the content data generated at the client terminals, further comprising a data transmitting position detector portion 212 for detecting a present transmitting position of the content data, and a mid-opening content producing portion 213 for producing content information for use of mid-opening, by determining the data position where the playback is stopped when receiving a playback stopping request as a playback starting position, wherein the content data from the playback starting position is transmitted by referring to the content information for use of mid-opening within the content information list memory portion 112 when staring the viewing/listening playback.”

### PRIOR ART DOCUMENTS

### Patent Documents

[Patent Document 1] Japanese Patent Laying-Open No. 2006-155828 (2006); and

[Patent Document 2] Japanese Patent Laying-Open No. 2005-323068 (2005).

### SUMMARY OF THE INVENTION

However, the apparatus disclosed in the Patent Document 1, since not taking anything into the consideration, in relation to renewal of the management information, is bad in the usability thereof for a user.

Also, in the Patent Document 2, no consideration is paid on the fact that the contents are played back in a server, nor compatibility between the server and the client.

For dissolving the problem(s) mentioned above, according to the present invention, such structures as is described in the pending claims that will be mentioned later are adopted.

The present application includes plural numbers of means for dissolving the problems mentioned above; however, if listing up an example thereof, there is provided a transmitting apparatus, comprising: a playback portion, which is configured to play back content; a content transmitting portion, which is configured to transmit said content through a network; and a controlling portion, which is configured to hold chapter information for indicating separation of a scene of said content, and to transmit said chapter information held therein through said network, wherein said controlling portion renews the chapter information held therein, when producing the chapter information, and when obtaining the chapter information, which is generated in other apparatus differing from said transmitting apparatus, through said network.

Also, if listing up other example thereof, there is also provided a receiving apparatus, comprising: a playback means for playing back content; a content transmitting means for transmitting said content through a network; a resume information managing means for managing first resume information for indicating a position of interrupting playback of content; and a resume information obtaining means for obtaining second resume information for indicating the position of interrupting playback of said content, wherein said resume information managing portion renews the first resume information when playback of said content by the playback means is interrupted, or when obtaining said second resume information through the resume information obtaining means.

With such the means as was mentioned above, in the viewing/listening of the contents via the network, it is possible to play back the content from a position, which is convenient for the user, and thereby enabling an improve of the usability for the user.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is a block diagram for showing an example of the structure of a system;

FIG. 2 is a block diagram for showing an example of the structures of a transmitting apparatus 110;

FIG. 3 is a block diagram for showing an example of the structures of a receiving apparatus 130 or 140;

FIG. 4 is a view for showing an example of server device information to be distributed by the transmitting apparatus 110;

FIG. 5 is a view for showing an example of service description information to be distributed by the transmitting apparatus 110;

FIG. 6 is a view for showing an example of content information including chapter information therein, to be managed by the transmitting apparatus 110;

FIG. 7 is a flowchart for showing an example of series of processes, for delivering the chapter information between the transmitting apparatus 110 and the receiving apparatus 130 or 140;

FIG. 8 is a view for showing an example of a display screen to be used by a user to make a chapter operation thereon;

FIG. 9 is a view for showing an example of the structure of additional information of content data, to be dealt with by the transmitting apparatus 110, or the receiving apparatus 130 or 140;

FIG. 10 is a view for showing an example of the structure of the chapter information to be delivered between the transmitting apparatus 110 and the receiving apparatus 130 or 140;

FIG. 11 is a view for showing an example of the structures of an apparatus, comprising the structures of the transmitting apparatus 110 and the receiving apparatus 130 or 140 as a transmitting portion and a receiving portion, respectively;

FIG. 12 is a block diagram for showing an example of the structures of a system;

FIG. 13 is a block diagram for showing an example of the structures of the transmitting apparatus 1210;

FIG. 14 is a block diagram for showing an example of the structures of the receiving apparatus 1230 or 1240;

FIG. 15 is a view for showing an example of server device information to be distributed by the transmitting apparatus 1210;

FIG. 16 is a view for showing an example of service description information to be distributed by the transmitting apparatus 1210;

FIG. 17 is a view for showing an example of content information including resume information therein, to be managed by the transmitting apparatus 1210;

FIG. 18 is a flowchart for showing an example of series of processes, for delivering the resume information between the transmitting apparatus 1210 and the receiving apparatus 1230 or 1240, when starting/stopping playback of content;

FIG. 19 is a view for showing an example of a display screen to be provided by the receiving apparatus 1230 or 1240 to the user, when playing back the content; and

FIG. 20 is a view for showing an example of the structure of additional information of content data to be dealt with by the transmitting apparatus 1210 and the receiving apparatus 1230 or 1240.

### DESCRIPTION OF THE EMBODIMENTS

Hereinafter, embodiments according to the present invention will be fully explained by referring to the attached drawings. However, the present invention should not be limited to the configurations, which will be shown by the embodiments.

FIG. 1 is a view for showing an example of the structure of a home network system including a transmitting apparatus and a receiving apparatus, according to the present embodiment.

A reference numeral 110 depicts the transmitting apparatus (e.g., a server) for transmitting a video content, such as, a moving picture and/or an audio, to the receiving apparatus (e.g., a receiving apparatus 130 or 140, which will be mentioned later) on a home network 100, and it is an apparatus for managing chapter information indicative of a scene punctuation or separation for content, according to the present embodiment.

As such a transmitting apparatus can be considered a television apparatus having a recorder or a recoding function, for example, and if it does not have a display device, such as, the built-in recorder therein, for example, as is shown in the figure, a display device 120 (a television set, etc.) is connected with, so as to display the content played back thereon.

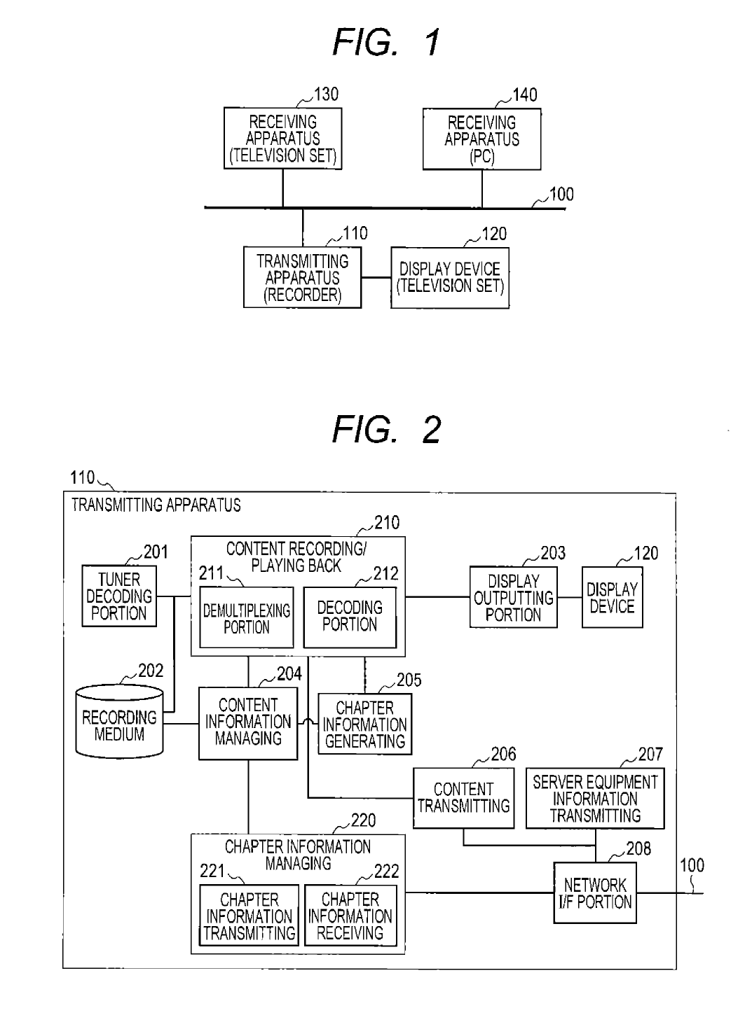

For that connection may be used an analog or a digital interface for outputting analog or digital video data/audio data. Explanation of an example of the detailed structure of this transmitting apparatus 110 will be mentioned later, by referring to FIG. 2.

Reference numerals 130 and 140 depict receiving apparatuses (e.g., the clients), respectively, for receiving the video content, such as, the moving picture or the audio, from the transmitting apparatus 110 on the home network 100, and is an apparatus for receiving and transmitting the chapter information indicative of the scene separation of content, according to the present embodiment, to the transmitting apparatus 110.

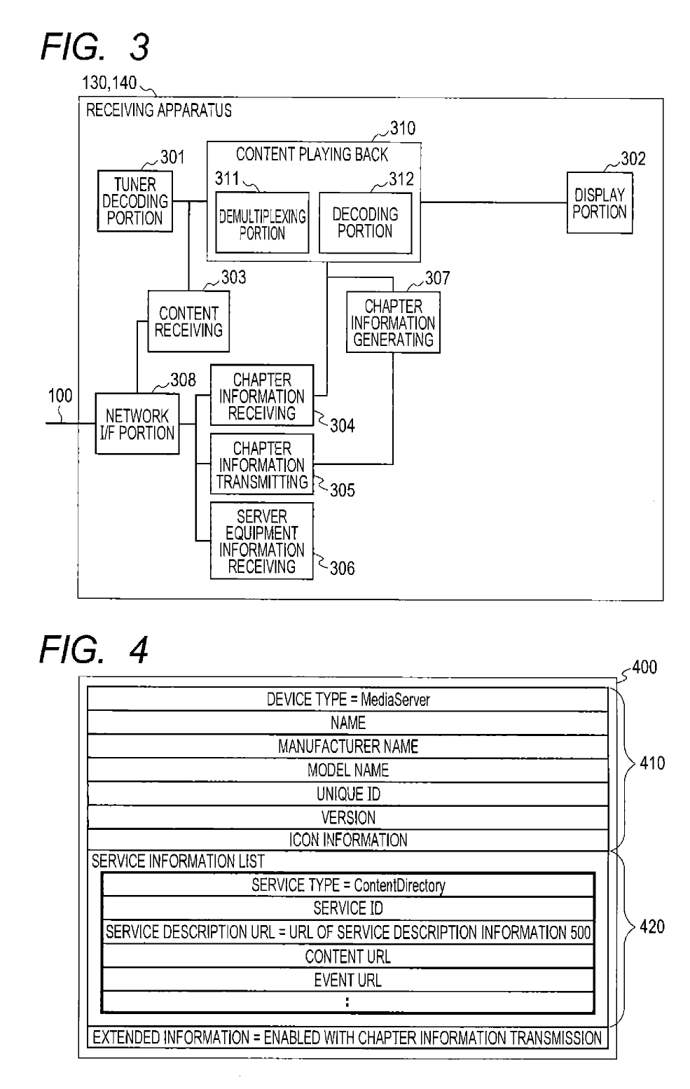

As such a transmitting apparatus can be considered a television set or a personal computer (PC), for example, but if not including a built-in display device therein, although not shown in the figure, like a STB (Set Top Box), for example, the display device (such as, the television set) may be connected with, so as to display the content played back thereon. Explanation of the detailed structures of those receiving apparatuses 130 and 140 will be mentioned later, by referring to FIG. 3. Also, though it will not be explained in the present embodiment; however, there can be considered an apparatus, quipped with both functions of the transmitting apparatus and the receiving apparatus. With such the apparatus, it is enough to achieve the respective functions (the structures and the control methods) of the transmitting apparatus and the receiving apparatus, which will be explained hereinafter. And, such a home network 100 may be constructed with a well-known IP (Internet Protocol) network, for example.

Next, explanation will be given on an example of the detailed structures of the transmitting apparatus, by referring to FIG. 2.

The transmitting apparatus 110 is an apparatus, for receiving a digital broadcast thereon, so as to conduct recording and playback of content, and thereby transmitting the content to the receiving apparatus on the home network 110. Regarding the recording of the content, it is applicable that, which can be obtained via receiving an IP broadcast through the network or downloading.

However, herein, explanation will be given on the case of treating a signal, which is encoded with an MPEG (Moving Picture Expert Group) as a video compression technology, and multiplexed with an MPEG2-TS method.

A tuner decoding portion 201 receives a digital broadcast signal, which is transmitted via a broadcast transmission network, such as, by radio (e.g., satellite or terrestrial) or a cable, etc. A tuning process and a detection process are treated on the frequency of a channel, which is designated with an instruction made by a user through a remote controller, etc. Also, the MPEG2-TS (transport stream), after being treated with a digital demodulation and an error correction process thereon, is outputted to a demultiplexing portion 211, via a selector not shown in the figure, as an output thereof.

The separation/extracting portion 211 separates/extracts a transport packet of a channel (e.g., a program), which is designated with the instruction made by the user through the remote controller, etc., from the MPEG2-TS. The transport packet being separated/extracted, in case when playing back the content, is further treated with separation/extraction of a PES (Packetized Elementary Stream) or an ES (Elementary Stream) of the video and the audio, to be outputted to a decoding portion 212, and in case when recording the content, it is further added with the information of a time stamp, to be outputted to a content management portion 204.

When playing back the content, the decoding portion 212 takes out the PES or the ES of the video/audio to decode therein, and outputs the video/audio decoded are outputted to a display output portion 203.

The display output portion 203 outputs the video/audio decoded to an external display device 120, via the digital and/or analog interface not shown in the figure. In this instance, an operation screen image to be presented to the user, such as, a menu or a list of contents, etc., which is generated in a drawing portion not shown in the figure, is composed on the video decoded, to be outputted.

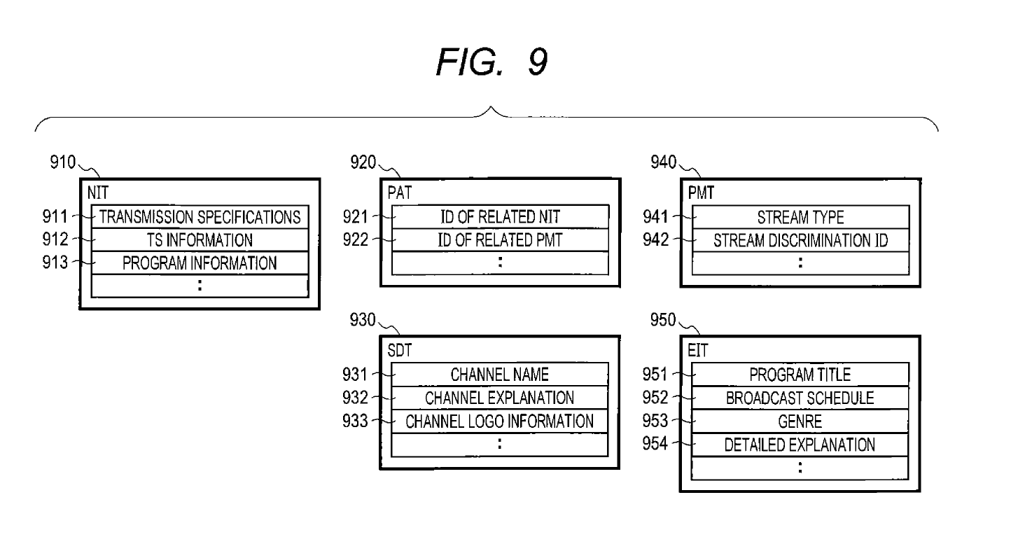

When recoding the content, the separation/extracting portion 211 detects information, such as, a title and/or a genre of the channel (e.g., the program) to be recorded on a recording medium 202, and/or format information, etc., from the transport packet of the channel (e.g., the program), which is designated with the instruction made by the user through the remote controller, etc., and outputs those to a content information managing portion 204. That information indicative of the title, the genre and/or a broadcasting schedule, etc., is to be stored in a PSI or an SI information of the MPEG-TS, for example (regarding explanation of an outline of the PSI and the SI information will be mentioned later, by referring to FIG. 9).

The content information managing portion 204 produces management information upon basis of the information, such as, the title, etc., from the separation/extracting portion 211, and also it conducts recording for the transport packet inputted from the separation/extracting portion 211 on the recording medium 202 upon basis of the management information mentioned above. In this instance, it is treated with an appropriate encoding process thereon, via an encoding portion not shown in the figure, to be recorded.

On the other hand, when transmitting the content recorded on the recording medium 202 to the receiving apparatuses 130 and 140 on the home network 100, firstly the transport packets of the content recorded on the recording medium 202, which is designated with the instruction made by the user through the remote controller, etc., are read out successively, and those are outputted to a content transmitting portion 206. In this instance, it is treated with the decoding of content thereon, through an encoding/decoding portion not shown in the figure, and is also treated with an encoding process thereon, to be outputted on the home network.

The content transmitting portion 206 removes the time stamp information from the transport packet, which is decoded and added with the time stamp thereto, and outputs it to a network I/F portion 208. The content transmitting portion 206, other than this, receives a transmission start request and a transmission stop request of the content from the receiving apparatuses 130 and 140, through the network I/F 208.

This request for transmitting the content is accepted as the parameters, each describing the position to start the transmission of content and/or the length thereof. When receiving this request, the transport packet(s) along the request is/are read out while executing a control, such as, a cue (search) designation or a length designation, appropriately, upon the content(s) recorded on the recording medium 202, and is/are outputted to the network I/F portion 208. On the other hand, when receiving the request for stopping the transmission, the output to the network I/F portion 208 is stepped, and also the readout of the transport packet(s) from the recording medium 202 is stopped.

The network I/F portion 208 outputs the transport packet(s), which is/are inputted from the content transmitting portion 206, to the receiving apparatuses 130 and 140, via the home network 100, while executing a conversion into the format along a transmission regulation and a flow control thereon. The network I/F portion 208 is also used, other than this, for example, in case when transmitting and/or receiving the information, such as, the chapter information or server device information, or service description information, etc., which will be mentioned later, to the receiving apparatuses 130 and 140 on the home network 100.

The transmitting apparatus 110 further includes a chapter information producing portion 205 for producing the chapter information indicative of the scene separation of content within the recording medium 202, a server device information transmitting portion 207 for transmitting the server device information attached with the information indicating that it has a chapter information transmitting function, as well as, a control method thereof, and a chapter information managing portion 220 for managing the chapter information indicative of the scene separation of content within the recording medium 202.

The chapter information managing portion 220 further includes a chapter information transmitting portion 221 for transmitting the chapter information to the receiving apparatuses 130 and 140, through the network I/F portion 208, and a chapter information receiving portion 222 for receiving the chapter information indicative of the scene separation of content, which is generated/renewed in the receiving apparatus 130 or 140.

Next, explanation will be made on an example of the detailed structures of the receiving apparatuses 130 and 140, by referring to FIG. 3. Herein, explanation will be given by referring the receiving apparatus 130 as an example.

The receiving apparatus 130 is an apparatus for receiving the digital broadcast, and the content from the transmitting apparatus 110 on the home network 100, and for playing back the content therein.

When receiving and playing back the digital broadcast, a tuner decoding portion 301 receives a digital broadcast signal, which is transmitted via a broadcast transmission network, such as, the radio (e.g., satellite or terrestrial) or a cable, etc. The tuner decoding portion 301 treats the tuning process and the detection process on the frequency of the channel, which is designated with the instruction made by the user through the remote controller, etc. Also, it outputs the MPEG2-TS (transport stream) after being treated with the digital decoding and the error correction process thereon, to a demultiplexing portion 311, via a selector not shown in the figure.

The demultiplexing portion 311 separates/extracts the transport packet of the channel (e.g., the program), which is designated with the instruction made by the user through the remote controller, etc., from the MPEG2-TS inputted. The transport packet, being separated/extracted, is further treated with the separation/extraction of the PES (Packetized Elementary Stream) or the ES (Elementary Stream) of the video and the audio, to be outputted to a decoding portion 312.

On the other hand, when playing back the content, which is received from the transmitting apparatus 11 on the home network 100, firstly it receives the transport packets of the content, which the transmitting apparatus 110 transmits as a result of designation made by the user through the remote controller, successively, via a network I/F portion 308.

The network I/F portion 308 receives the transport packet to be outputted to a content receiving portion 303 from the transmitting apparatus 110, via the home network 100, while executing the conversion from the format along the transmission regulation and the flow control thereon. The network I/F portion 308 is also used, other than this, when transmitting and/or receiving the information, such as, the chapter information or the server device information, or the service description information, etc., which will be mentioned later, to/from the receiving apparatus 110, etc., on the home network 100.

The transport packet, being received through the network I/F portion 308, is outputted to the content receiving portion 303, and further, via a selector not shown in the figure, an output thereof is outputted to the demultiplexing portion 311. In this instance, via the network transmission decoding portion not shown in the figure, decoding is executed on the content, which is encoded when being transmitted through the network I/F.

The content receiving portion 303, other than this, transmits a transmission start request and a transmission stop request, with adding the position for starting the transmission of content and the length thereof, as the parameters thereto, upon basis of instructions, such as, a cur (or search) playing back (e.g., chapter skip) or a fast-forward playback, or start/stop of an interruption (or a pause), etc., which is made by the user through the remote controller or the like, via the network I/F 308, to the transmitting apparatus 110.

The demultiplexing portion 311 executes separation/extraction of the PES (Packetized Elementary Stream) or the ES (Elementary Stream) of the video and the audio, upon the transport packet, which is inputted from the content receiving portion 303, to be outputted to the decoding portion 312.

The decoding portion 312 takes out the PES or the ES of the video/audio, to be decoded, and the video/audio decoded are outputted to a display portion 302.

The display portion 302 displays the video/audio decoded. In this instance, an operation screen image to be presented to the user, such as, a menu or a list of contents, or a chapter, etc., which is generated in a drawing portion not shown in the figure, is composed on the video decoded, thereby to be displayed.

However, in the present embodiment, the transmitting apparatus 100 transmits the chapter information indicative of the separating position of the content to the receiving apparatuses 130 and 140, and the receiving apparatus is that provided for obtaining this to control (including the case where it is generated in the receiving apparatus). Herein, regarding means for producing the chapter information within the transmitting apparatus 110 or the receiving apparatuses 130 or 140, since various methods are already opened to the public, although omitting the detailed explanations thereof herein, but it is possible to apply a method, etc., with an instruction, which is made by the user from an inputting means, such as, the remote controller, etc.

The receiving apparatus 130 includes a chapter information producing portion 307 for producing or renewing the chapter information indicative of the scene separation of content, which is received from the transmitting apparatus 110 and played back therein, a server device information receiving portion 306 for receiving the server device information, to which the information is added, indicating to have the chapter information transmitting function, and the control method thereof, through the network I/F portion 308, a chapter receiving portion 304 for receiving the chapter information from the transmitting apparatus 110, and a chapter information transmitting portion 305 for transmitting the chapter information, which is generated or renewed by the chapter information producing portion 307 within the receiving apparatus 130.

Next, explanation will be made on an example of the server device information, to which the information is added indicating to have the chapter information transmitting function, by referring to FIG. 4. This is to be transmitted (or, returned) by the transmitting apparatus 110 responding to an request from the receiving apparatus 130 or 140, and is held in the server device information transmitting portion 207, which was explained by referring to FIG. 2.

The server device information 400 is constructed with, roughly, device information 410 for indicating a type or a model of the device, and a service information list 420 for indicating information of one or more numbers of services, which are provided by the device(s). The structure of this server device information 400 of itself is not an unique one to the transmitting apparatus (e.g., the server), but depending on a value of the information included herein, it is indicated that this is the transmitting apparatus (e.g., the server).

The device information 410 is constructed with, as shown in the figure, a device type indicative of a type of the device, a name, a manufacturer name, a model name, a unique ID, version and icon information, etc., as the information of the device itself having the server device information 400. And, in the case of the transmitting apparatus 110, description that the device type is “Media Server” is made, as is shown in the figure, for the purpose of indicating that it is the transmitting apparatus (e.g., the server).

The service information list 420 is constructed with, for example, a service type for indicating a type of the service, a service ID, a service description URL for indicating an accessing address to control details of that service, a control URL for indication a designation of control of that service, and an event URL for indicating a communication address of the service, etc., for each one (1) service, as the services to be provided by the device having that server device information 400.

In the present embodiment is applied a service for providing a content list, the service type of which is “Content Directory”, wherein the receiving apparatuses 130 and 140 can obtain the chapter information, for each content, with using the control method, which is described in the service description information 500 (the details thereof will be mentioned later) for showing the control details of this service.

And, the information indicating to have the chapter information transmitting function, according to the present invention, is described with using extended information 431, other than the device information 410 and the service information list 420. With doing in this manner, even in the receiving apparatus not enabling the use of the chapter information transmitting function, it is possible to interpret the device information 410 and the service information list 420 within the service device information 400.

Also, a method can be considered, i.e., describing the information indicating to have the chapter information transmitting function in the device information 410 or the service information list 420. In such case, various ways can be considered, for example, making such a presentation that the information indicating to have the chapter information transmitting function is the information, which is extended in the device information 410 or the service information list 420, respectively, or making such description at the end thereof, etc.

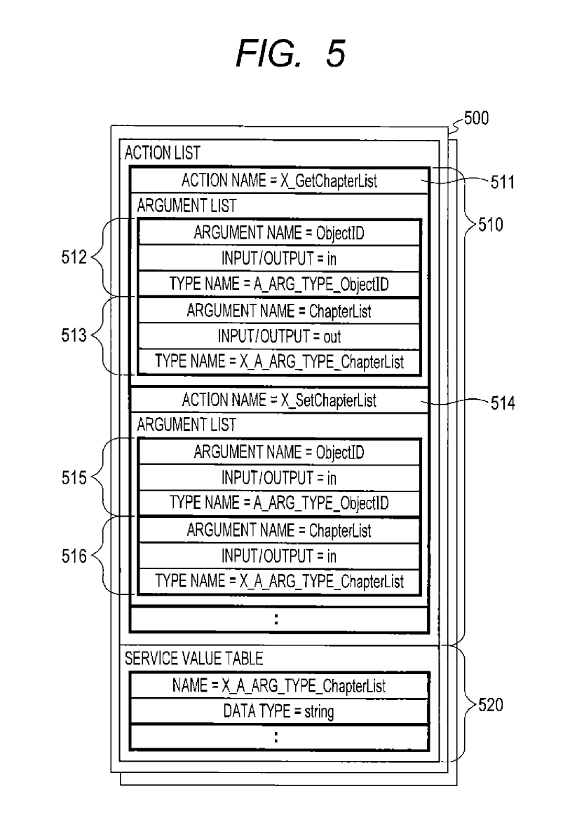

Next, explanation will be given on an example of the structures thereof, about the service description information 500 for indicating the control details of the service, in the service for providing the content list, the above-mentioned service type of which is “Content Directory”, by referring to FIG. 5. This is transmitted (or returned) by the transmitting apparatus 110 to a request from the receiving apparatus 130 or 140, and is held within the server device information transmitting portion 207, which was explained by referring to FIG. 2.

The service description information 500 is constructed with, roughly, an action list 510 for indicating one (1) or more numbers of action (control) method(s) for that service, and a service value table 520 for explaining a type of an input/output value of the action, which is described in the action list 510, and those are prepared for each of the services.

In the action list 510, as is shown in the figure, are described an action name and an argument list to be used in that action, for each action. In the argument list are described, an argument name, directions of input/output and a type name, for each argument. As an action in relation to obtaining and/or setup of the chapter information, according to the present invention, can be defined that shown in FIG. 5.

The action indicated by the action name “X_GetChapterList” 511 is for the transmitting apparatus 110 to return the chapter information 632, responding to the request from the receiving apparatus 130 or 140. In more details thereof, the receiving apparatus 130 or 140 makes a request, for obtaining the chapter information to the transmitting apparatus 110, by designating the argument, which is shown in the argument 512 (that having the argument name “ObjectID”).

And, the transmitting apparatus 110, receiving this obtaining request, returns the chapter information while setting up the argument shown in the argument 513 (that having the argument name “ChapterList”). However, the argument name “ObjectID” shown herein is an ID, for determining the content to be transmitted by the transmitting apparatus 110, uniquely (details thereof will be mentioned later). Namely, it is an action, in which the transmitting apparatus 110 returns the chapter information corresponding to the content, which is designated from the receiving apparatus 130 or 140.

The action indicated by the action name “X_SetChapterList” 514 is for the transmitting apparatus 110 to set up (renew) the chapter information 612 (will be mentioned later), responding a setup request from the receiving apparatus 130 or 140. In more details thereof, the receiving apparatus 130 or 140 makes a request for setting up the chapter information to the transmitting apparatus 110, by designating the arguments, which are shown in the argument 515 (that having the argument name “ObjectID”) and the argument 516 (that having the argument name “ChapterList”).

And, the transmitting apparatus 110, receiving this setup request, sets up (or renews) chapter information 632 (will be mentioned later) corresponding to the content, which is shown in “ObjectID” of the argument 515 and/or extended chapter information 642, with using the “ChapterList” shown in the argument 516. Namely, it is an action, in which the chapter information corresponding to the content, which is designated from the receiving apparatus 130 or 140.

The service value table 520 is a table for explaining the type of the input/output value of the action, as was mentioned previously, on which, as is shown in the figure, are described a name (corresponding to the type name in the action list 510) a data type of that type (a character string, a 4-bytes integer type having no mark, etc.), for each type.

In such actions “X_GetChapterList” and “X_SetChapterList” as was mentioned above, as is shown in the figure, since they use therein the type of name, such as, “X_A_ARG_TYPR_ChapterList”, for example, description is made about that type (i.e., a data type of the character string “string” is described). Namely, the argument “ChapterList” is presented by a character string (herein, it is assumed that the structure of the chapter information, which is presented by the character string, takes the structure of chapter information 1000, which will be mentioned later).

By referring to the server device information 400 and the service description information 500, which are shown in the above, it is possible for the receiving apparatuses 130 and 140 to obtain/set up the chapter information. However, each of the names mentioned herein is used only for showing the example thereof, but should not be limited to the names described herein.

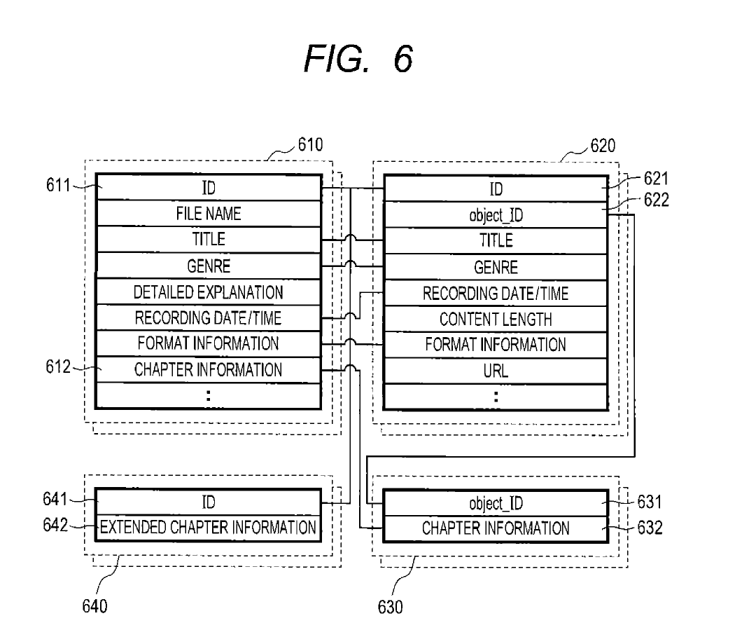

Next, explanation will be given on an example of the to structures of a table for managing the content recorded on the recording medium 202, the contents to the transmitted to the receiving apparatuses 130 and 140, and the chapter information for indicating the scene separation of content, in the transmitting apparatus 110, by referring to FIG. 6.

In FIG. 6, intra-recording medium content information 610 is a table for managing the information of the content(s) recorded on the recording medium 202, network distribution content information 620 is a table for managing the content(s) to be transmitted to the receiving apparatus(es) 130 and/or 140, and chapter information 630 is a table for managing the chapter information for indicating the scene separation of content between the receiving apparatuses 130 and 140.

Further, the extended chapter information 640 is a table for extending and managing the chapter information indicating the scene separation of content, as a table other than the intra-recording medium content information 610. For example, it is to be used in case when managing it as plural numbers of chapter lists, while attaching meaning to the chapter information depending on a genre of the content (for example, when allowing it to have a chapter list for use in a weather scene and a chapter list for a sport scene, in a new program), or when managing it while defining the operation of each chapter (for example, when defining an automatic skipping operation in a portion of content, which is not viewed/listened).

The intra-recording medium content information 610 is constructed with, for example, an ID 611 for determining the content, uniquely, and the chapter information 612 for indicating the scene separation of content, and also other than those, a file name, a title, a genre, detailed explanation, recoding date/time, format informing, etc., wherein those are prepared for each content.

The chapter information 612 may differs from, in a method of expression thereof, depending on a kind or a recording format of the recording medium 202. For example, a number of the chapters, which are included in that content, and also, a chapter number, a packet position or byte position from a top of the content, for indicating a position of the chapter, or a chapter position expressed by time, for each chapter, are held. And, this intra-recording medium content information 610 is to be held in the content information managing portion 204 (or the recording medium 202), which was explained by referring to FIG. 2.

The extended chapter information 640 is constructed with an ID 641 for determining the content, uniquely within the intra-recording medium content information 610, and extended chapter information 642 for extending the chapter information 612 of the intra-recording medium content information 610 mentioned above, etc., and those are prepared for each of the contents.

Herein, although the extended chapter information 642 takes the structure same to that of the chapter information 612 within the intra-recording medium content information 610, however as was mentioned previously, it is constructed with one (1) or more numbers of the chapter list(s), in which the chapter type is held for each chapter. And, this extended chapter information 640 is to be held in the content information managing portion 204 (or the recording medium 202), which was explained by referring to FIG. 2.

The network distribution content information 620 is constructed with, for example, an ID 621 for determining the content uniquely, within the intra-recording medium content information 610 (in the present embodiment, taking the same value of an ID 611), and an object_ID 622 for determining the content, uniquely, to be transmitted to the receiving apparatuses 130 and/or 140, and also other than those, a title, a genre, recording date/time, content length, format information and URL, etc., wherein those are prepared for each of the contents.

However, although the title, the genre, the recording date/time and the format information are prepared, herein, in form of duplicating with the intra-recording medium content information 610; however, those may not be prepared within the network distribution content information 620, necessarily. In that instance, it is enough to read out the information corresponding to the intra-recording medium content information 610 from the ID 621. And, this network distribution content information 620 is to be held in the content information managing portion 204 (or the recording medium 202), which was explained by referring to FIG. 2.

The chapter information 630 is constructed with an object_ID 631 for determining the content, uniquely, within the network distribution content information 620 (in the present embodiment, taking the value same to that of the ID 611), and chapter information 632 for indicating the scene separation of the content corresponding to that object_ID 631.

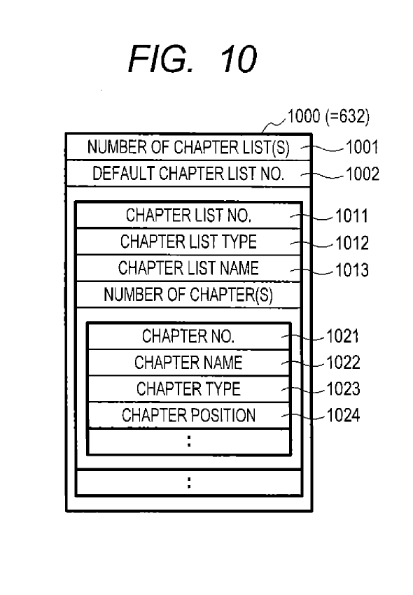

Herein, explanation will be given on the components of the chapter information 632, in further details thereof, by referring to FIG. 10. Chapter information 1000 (i.e., the chapter information 632), taking the components same to the argument “ChapterList” explained previously, is constructed with at least one (1) or more numbers of chapter list(s), in which a chapter list count for showing a number of the chapter list(s) thereof, a default chapter list number 1002 for designating a chapter list to be displayed at first, for example, wherein for each chapter list, there are held a chapter list number 1011, a chapter list type 1012, a chapter list name 1013, and a chapter count 1014 for showing a number of chapter(s), which is/are included in that chapter list, and further for each chapter, there are held a chapter number 1021, a chapter name 1022, a chapter type 1023, and a chapter position 1024. And, this chapter information 630 is to be held in the content information managing portion 204, which was explained by referring to FIG. 2.

However, herein, the structure of the chapter information 632 (thus, the structure of the argument “ChapterList”, too) includes the information of the respective names and/or types, etc., regarding the chapter list and/or the chapter; however, depending on the cases, it may be a simple one omitting those therefrom. For example, it may be components of describing only the chapter list name 1012 and the chapter position 1024, which is included in that chapter list, for each chapter list. In particular, as the structures of the argument “ChapterList”, since those components must be such ones that the transmitting apparatus 110 and the receiving apparatuses 130 and 140 can interpret them, mutually, it can be considered to add format information thereto, for showing the structure of the argument “ChapterList”.

Herein, explanation will be given about an outlook of the PSI and SI information, storing therein the title, the genre, the broadcasting schedule, etc., which are extracted by the transmitting apparatus 110 when recoding the content and are held in the intra-recording medium content information 610, by referring to FIG. 9.

The content multiplexed through MPEG-TS is transmitted, for example, in the broadcasting, in the form of one (1) or more number(s) of transport stream(s), in each frequency band region, converted through a frequency dividing method, etc. And, to each transport stream are multiplexed one (1) or more number(s) of content (a program), which is constructed with the video and the audio and data, to be transmitted.

In FIG. 9, on a NIT (Network Information Table) 910 are stored, mainly, a transmission specification 911 storing the frequency information for receiving a desired program from airwaves, TS (Transport Stream) information 912, including a kind or sort of transmission of the transport stream corresponding to that transmission specification, and program information 913, including the information of the channel number corresponding to that transmission specification, etc., and so on.

In PAT (Program Association Table) 920 are stored an identification ID 921 to the NIT 910, which is included in that transport stream, and or an identification ID 922 to PMT 940, which will be mentioned later, for each channel (e.g., the program).

In SDT (Service Description Table) 930 are stored a channel name 931, a channel explanation 932, and channel logo information 933, such as, link information to logo data of the channel, etc., which are included in that transport stream, and so on, for each channel.

In PMT (Program Map Table) 940 are stored a stream type 941 (for identifying between a digital television service and a digital radio audio service, etc.), and a stream identification number 942 for identifying actual data, into which that stream is stored, etc., for each stream.

In EIT (Event Information Table) 950 are stored a program title 951, a broadcasting schedule 952 for showing start time/end time of the program, a genre 953 for identifying a genre of the program, and a detailed explanation 954 for showing explaining sentences of the program, etc., for each channel. And, on those tables are stored IDs, each for uniquely determining the transport stream, the channel and the program (not shown in the figure) corresponding thereto, respectively, and they are related with each other.

And, the transmitting apparatus 110 extracts the title, the genre and/or the broadcasting schedule, etc., corresponding to the content (e.g., the program) to be recorded on the recording medium 202, from those information, and holds them in the intra-recording medium content information 610.

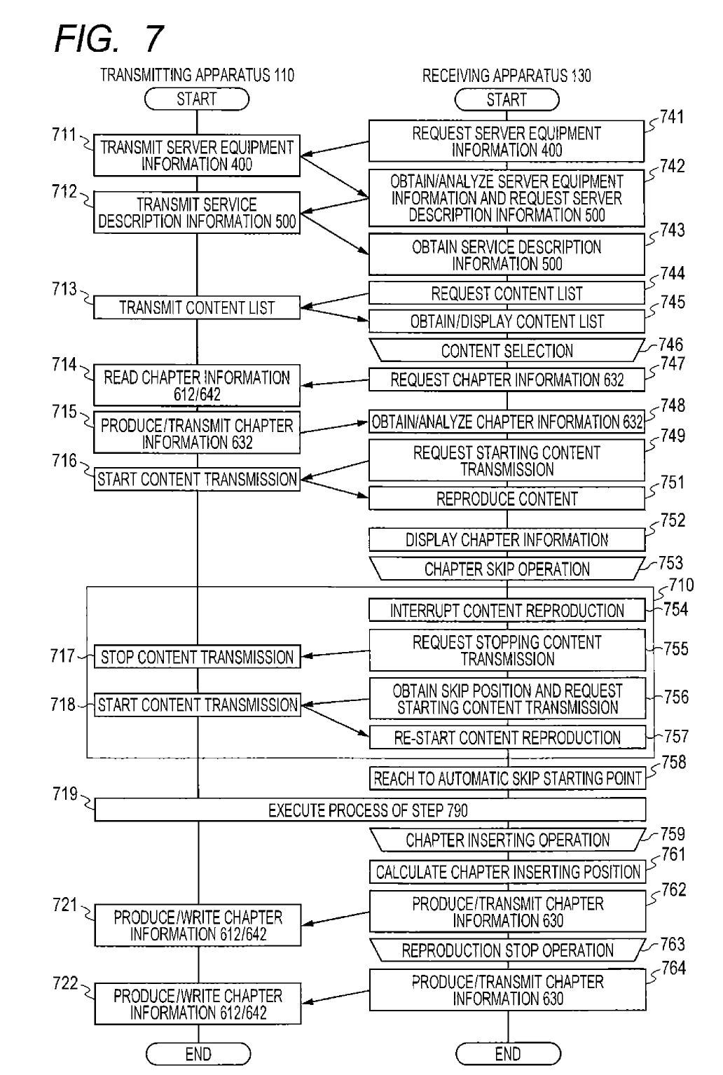

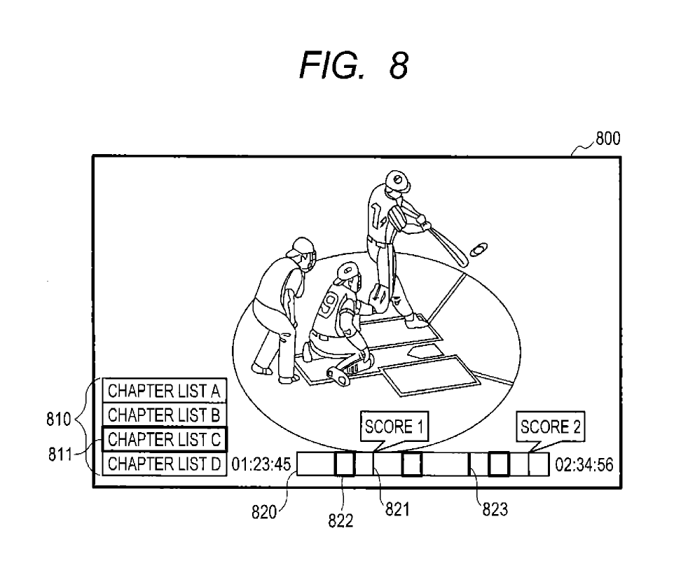

Next, explanation will be given on an example of a method for exchanging the chapter information between the transmitting apparatus 110 and the receiving apparatus 130 or 140, in the home network 100, with using the server device information 400, the service description information 500, the intra-recording medium content information 610, the network distribution content information 620, the chapter information 630 and the extended chapter information 640, by referring to FIG. 7 for showing a flowchart thereof and FIG. 8 for showing an operation screen to be presented to a user.

In the flowchart shown in FIG. 7 are listed an example where the content recorded in the recording medium 202 of the transmitting apparatus 110 (the chapter information is already generated) is received and played back by the receiving apparatus 130, so as to provide the chapter information of that content to the user, thereby executing a chapter skip, and an example of case where the chapter skip is executed, automatically, without an operation by the user.

Further, thereafter is listed up an example of the case where the chapter information is renewed on the side of the receiving apparatus 130 (i.e., in case when inserting the chapter and when renewing the default chapter list), thereby to set that chapter information to the transmitting apparatus 110.

First of all, on the receiving apparatus 130, the user instructs a list display operation of contents, which are opened on the home network 100, for conducting the playback of the content recorded on the recording medium 202 of the transmitting apparatus 110 (this step is not shown in the figure).

The receiving apparatus 130 receiving this instruction, first of all, gives a request for the server device information 400 to the device on the home network 100 through the server device information receiving portion 306 (this request is also conducted to the transmitting apparatus 110) (step 741).

The transmitting apparatus 110 receiving this request reads out the server device information 400 through the server device information transmitting portion 207, and transmits (or turns back) it to the receiving apparatus 130 (step 711). The receiving apparatus 130 receiving the server device information 400 through the server device information receiving portion 306, interprets the structure, which was described in the explanation in FIG. 4, and it also request the service description information 500 (step 742). Depending on the interpretation of chapter information transmission response information 431 within the server device information 400 in this step 742, for the receiving apparatus 130, it is possible to see that the transmitting apparatus 110 is enabled with functions for transmitting and setting up the chapter information.

And next, the transmitting apparatus 110 receiving the request of the service description information 500 reads out the service description information 500 through the server device information transmitting portion 207, and transmits (or turns back) this to the receiving apparatus 130 (step 712).

The receiving apparatus 130, receiving the service description information 500 through the server device information receiving portion 306, interprets the structure, which is described in the explanation in FIG. 5 (step 743). Depending on the interpretation of the action list 510 and the service value table 520 within the service description information 500, in this step, for the receiving apparatus 130, it is possible to know the methods for transmitting and setting up the chapter information to the transmitting apparatus 110.

Next, the receiving apparatus 130 transmits the content list information to execute a list display of content(s) to the transmitting apparatus 110 (step 744). This is done upon basis of the action list 510 within the service description information 500 and the method described on the service value table 520.

The transmitting apparatus receiving the request for the content list information transmits (or turns back) the information fitting to the request of the receiving apparatus 130, by referring to the network distribution content information 620 (step 713). And, the receiving apparatus 130 receives that content list information, and executes the list display of the content(s) with using that information (step 745). In this step, an image drawn for the list display is generated in a drawing portion, which is not shown in the figure, and is outputted to the display portion 302.

Next, from the content list displayed, the user selects the content which she/he desires, and conducts a playback instruction (step 746).

The receiving apparatus 130 receiving the playback instruction, next through the chapter information receiving portion, gives an (obtaining) request for the chapter information 632 of that content to the transmitting apparatus 110 (step 747). This is done in accordance with the method, which is described in the action list 510 (using the action name 511 and the arguments 512 and 513).

And, the transmitting apparatus 110 receiving the (obtaining) request for the chapter information 632 reads out the chapter information, which is described in the chapter information 612 and/or the extended chapter information 642 of the content corresponding thereto, while tracing back the network distribution content information 620, the intra-recording medium content information 610 and the extended chapter information 640, upon basis of the value of the ObjectID, which is described in the argument 512 (step 714).

And, it generates the chapter information 632, by converting the value(s) of the chapter information 612 and/or the extended chapter information 642 into the form of the chapter information 632, and transmits (or turns back) this to the receiving apparatus 130 (step 715). Next, the receiving apparatus 130 receives that chapter information 632 through the chapter information receiving portion 306, and analyzes the chapter information (step 748).

Next, the receiving apparatus 130 request a start of transmission of content to the transmitting apparatus 110, through the content receiving portion (step 749). The transmitting apparatus 110 transmits the content data in accordance with the start request of transmission of content in the step 749, through the content transmitting portion 206 (step 716), while the receiving apparatus 130 receives that content data through the content receiving portion 303, successively, and executes playback of the content through the content playback portion 310 (step 751).

However, in this instance, the receiving apparatus 130 observes the playback position of that content, for the purpose of skipping the playback of that chapter, in case where the playback position of that content is that of the chapter, an object for automatic skipping. In more details, firstly, upon basis of a result of the analysis in the step 748, a start point of the chapter to be skipped automatically is obtained from a chapter position 1024. Next, observation is made about if the playback position of that content reaches to that chapter position 1024 or not.

Herein, for the user to execute the chapter operation, an instruction is executed for requesting to display the chapter information (this step is not shown in the figure). The receiving apparatus 130 receiving this instruction provides an operation screen for executing the chapter operation (step 752). In this present step, the chapter information relating to that chapter list is displayed, by referring to a default chapter list number 1002 within the chapter information 1000 (=the chapter information 632).

However, in such a case when displaying the chapter information, again, after displaying/deleting the chapter information once, there may be also considered a method of using the chapter list number memorized, but not the default chapter list number 1002, when displaying it again, while memorizing the chapter list number of the chapter list, which is displayed at the last, when deleting the display of the chapter information.

This operation screen is for executing an operation of selecting a certain chapter list, in particular, in case where there are plural numbers of operations for skipping the chapter or plural numbers of chapter lists, for example, and it takes such the structure as shown in FIG. 8. In this FIG. 8, a reference numeral 800 depicts a chapter operation screen, and this screen is built up with a chapter list display portion 810 and a chapter display portion 820, roughly.

FIG. 8 shows the condition where a chapter list C811 is selected, wherein the chapter information in that chapter list is shown by a time-base format while the playback position at the present time is shown by a drawing 823 or a time character string. In this instance, for example, when the user selects other chapter list than the chapter list C811, the chapter information in that chapter list is drawn, again.

In a chapter list display portion 810 is displayed the chapter list, which is described in the chapter information 1000, with using the chapter list number 1011 and/or the chapter list name 1012.

In a chapter display portion 820 is displayed those about the chapter(s) relating to that chapter list 811, with using the information of the chapter number 1021 or the chapter name 1022, or the chapter type 1023 or the chapter position 1024. However, when displaying the position of each chapter by the time-base format, to it is calculated with using the information of content length and that chapter position, which are included in the content list information obtained in the step 745.

As the chapter type may be defined, for example, as a position (starting position) for executing the automatic skipping operation, at a portion where no viewing/listening is made on the content. For the chapter of such chapter type, as is shown by the drawing 822, display is made while separating it from other chapter (such as, the drawing 821, etc.)

Then, herein if the user gives an instruction of skipping the playback of content at the starting point of the next chapter (step 753), the receiving apparatus 130 executes a series of processes for executing a skip playback, which are shown in the step 710).

In the step 710, first of all, the receiving apparatus 130 gives a request to the transmitting apparatus 110, to stop the transmission of the content corresponding thereto (step 754). And, the receiving apparatus 110, upon receipt of that request to stop transmission, stops the transmission of that content (step 717). Thereafter, the receiving apparatus 130 obtains the chapter position 1024 of the chapter, which is time-sequentially disposed just after, from that playback position, upon basis of the playback position of the content at the time point when the user conducts the skipping instruction. And, it gives a request to the transmitting apparatus 110, to start the transmission of content with designating the starting position for transmission (step 756). The transmitting apparatus 110 executes the transmission of content data in accordance with the starting request for the transmission of content in the step 756, through the content transmitting portion 206 (step 718), while the receiving apparatus 130 starts the playback of content, again, in the similar manner to that in the step 751 (step 757).

Next, when the playback potion of content reaches to the portion, at which not viewing/listening is made as was mentioned previously in FIG. 8, detection is made on that fact of reaching to the starting point of that chapter, upon which the observation was made in advance (step 758), and thereafter, the series of processes in the step 710 mentioned previously are executed.

Next, when the user inserts the chapter into a certain position of the content (this is instructed when an operation is made on the screen shown in FIG. 8, or through an operation on a chapter insert button, which is assigned on a remote controller) (step 759), first of all, the receiving apparatus 130 calculates an insert portion, which is instructed by the user (step 761).

And, in order to set up the information calculated into the transmitting apparatus 110, the receiving apparatus 130 generates the chapter information 630 and transmit it to the transmitting apparatus 110 (step 762). This is done, in accordance with the method described in the action list 510 (with using the action name 514 and the arguments 515 and 516).

And, the transmitting apparatus 110, upon receipt of the (setup) request of the chapter information 630, generates the chapter information 612 and 642 of the content corresponding thereto, upon basis of the ChapeterList, which is described in the argument 516, while tracing back the network distribution content information 620, the intra-recording medium content information 610 and the extended chapter information 640 upon basis of the value of the ObjectID, which is described in the argument 515, and thereby writing them therein (step 721).

Next, when the user stops the playback of content (step 763), first of all, the receiving apparatus 130 compares the default chapter list number 1002 within the chapter information 632 (=the chapter information 1000), which is received from the transmitting apparatus 110, with the number of the chapter list, which is selected at the last (this step is not shown in the figure).

And, if there is a difference in that comparison, it generates (or renews) the chapter information 630, and transmits this to the transmitting apparatus 110, in the same manner to that in the step 764 (step 764). At the last, the transmitting apparatus 110, upon receipt of the (setup) request of the chapter information 630, renews the chapter information 612 and 642, in the similar manner to that shown in the step 721.

With doing as was mentioned above, the receiving apparatus (e.g., the client) is able, not only to obtain the structure information of the chapter from the transmitting apparatus (e.g., the server), but also to set up the chapter structure information, which is set up (i.e., inserted or renewed) in the client, into the server. Further, it is possible to manage the chapter information of content, uniquely, on the home network.

Also, even in case where the structure of chapter is not constructed with the plural numbers of chapter lists, corresponding to the meanings of the chapters, that structure information can be obtained by the server and the client, mutually. Since that structure information has a common structure, not depending on the recording medium, and further, the server is so structured that it converts the chapter structure information depending on the recording medium into this common structure, it is possible for the client to interpret the chapter information, without recognizing the server (or the recording medium thereof).

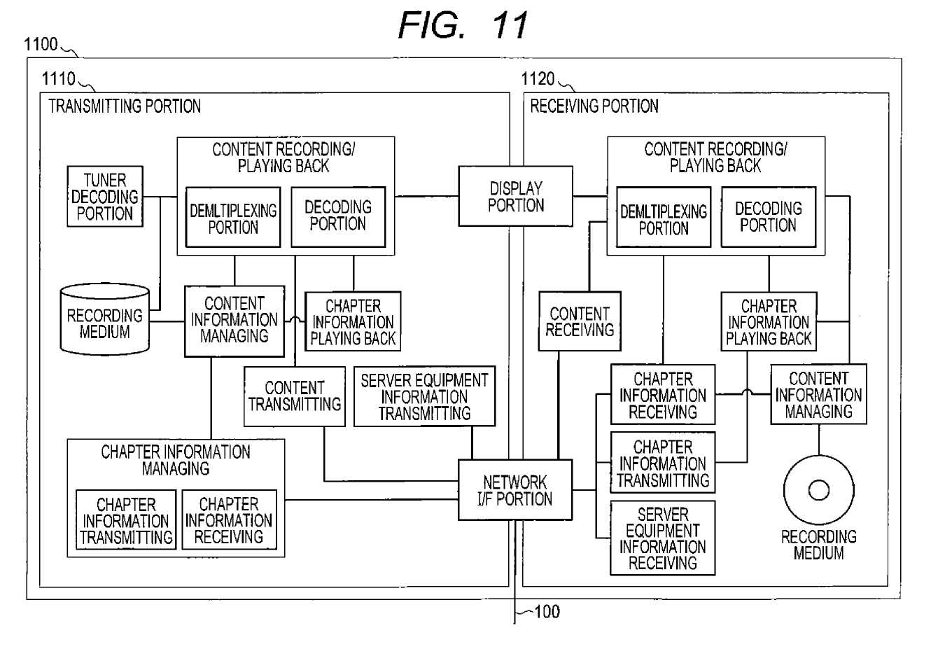

However, the present embodiment is also applicable into case where the structures of the transmitting apparatus 110 and the receiving apparatuses 130 and 140, which are explained herein, are built up as one (1) apparatus, for each, as a transmitting portion and the receiving portion, respectively. In such case, for example, as is shown in FIG. 11, the transmitting portion and the receiving portion are structured to be connected with each other through a network I/F, or a display portion can receive signals from both the transmitting portion and the receiving portion.

With doing in this way, even if the managing method of the chapter information differs on each recording medium, it is possible to deliver the chapter information, mutually, and also when delivering the chapter information between external transmitting apparatus and/or receiving apparatus, which are connected with the home network 100, it is possible to uniform processes for that to be common with.

However, in the embodiment mentioned above, though the explanation was given that the transmitting apparatus shown in FIG. 2 and the receiving apparatus shown in FIG. 3 have blocks 201-222 and the blocks 301-312, respectively, but in each of the apparatuses, they may be structured with one (1) or plural numbers of CPU(s) for achieving those functions that those blocks have, and/or a function not shown in the figure. For example, the blocks 204, 205, 206, 207, 210 and 220 in the transmitting apparatus 110 have may be built up with one (1) piece of CPU, so that the functions that they have can be achieved therewith. The above mentioned is also true to the apparatuses shown in FIG. 11.

Next, explanation will be given on other embodiment preferable for the present invention. However, the present invention should not be limited to the configuration shown in the present embodiment.

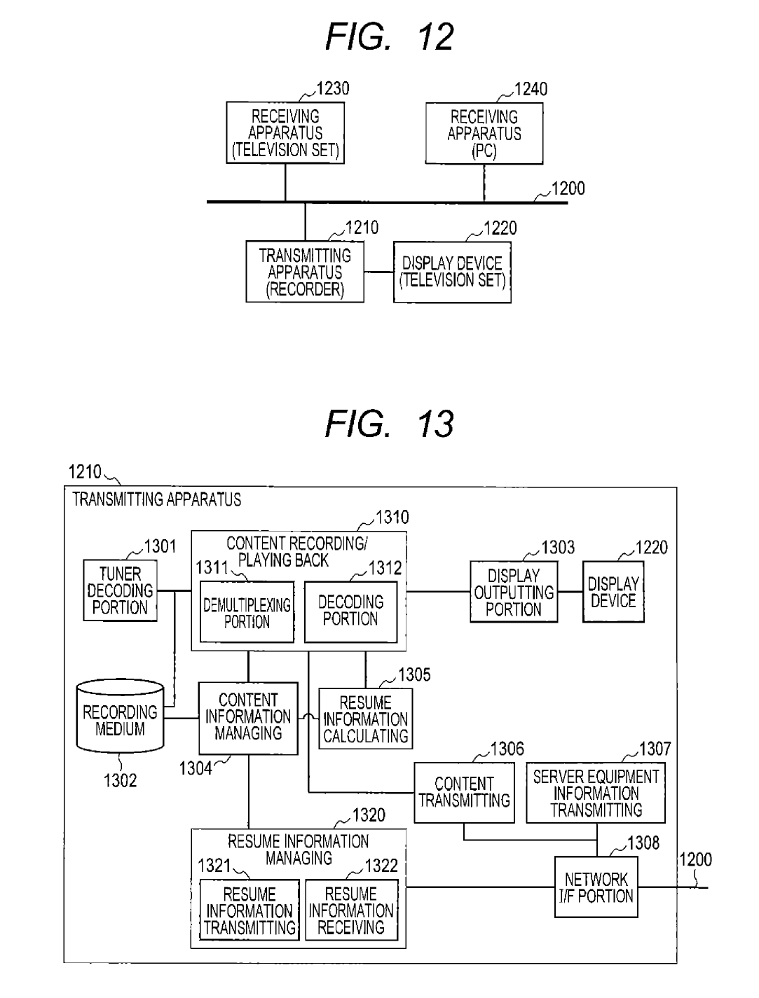

FIG. 12 shows an example of the structure of a home networks system, which is constructed with the transmitting apparatus and the receiving apparatuses.

A reference numeral depicts the transmitting apparatus (e.g., the server) for transmitting the moving picture, audio and/or the video content to the receiving apparatus (the receiving apparatus 1230 or 1240, which will be mentioned later) on the home network system 1200, and is an apparatus for managing resume information for indicating a portion where playback of content is interrupted.

As an example of such transmitting apparatus can be considered a television set attached with a recorder or a recording function, for example, and in case where it does not have a built-in display device, such as, the recorder, for example, as is shown in the figure, a display deice 1220 (such as, the television set, for example) is connected with, so as to display the content played back thereon.

For that connection, nay be applied an analog or a digital interface, for outputting analog or digital video data/audio data. Explanation regarding the detailed structures of this transmitting apparatus 1210 will be mentioned later, by referring to FIG. 13.

Reference numerals 1230 and 1240 depict the receiving apparatuses (e.g., the clients), for receiving and playing back the moving picture, the audio and/or the video content from the transmitting apparatus 1210 on the home network 120, and are apparatuses for receiving and transmitting the resume information for indicating the portion where the playback of content is interrupted.

As such the receiving apparatus can be considered, for example, a television set or a PC (personal computer), and not shown in the figure, in case where no display device is built therein, for example, like a STB (Set Top Box), the display device (such as, the television set, etc.) is connected with, as like the transmitting apparatus 1210 mentioned above, so as to display the content played back thereon.

Also, though not explaining in the present embodiment, an apparatus can be considered, which has both functions of the transmitting apparatus and the receiving apparatus. In such apparatus, it is enough that the respective functions (the structures and the control methods) of the transmitting apparatus and the receiving apparatus, which will be explained hereinafter, can be achieved therein.

Next, explanation will be given on an example of the detailed structures of the transmitting apparatus 1210, by referring to FIG. 13.

The transmitting apparatus 1210 is an apparatus for receiving the digital broadcast, and for recording and playing back of content and transmitting the content to the receiving apparatus(es) on the home network 1200. Regarding the recording of content, it is possible to apply that for receiving the IP broadcast via the network or downloading thereof. However, herein, explanation will be given on the case when treating a signal, which is encoded with the MPEG (Moving Picture Experts Group) method, as the video compression technology, and is multiplexed with the MPEG2-TS method.

A tuner decoding portion 1301 receives a digital broadcast signal, which is transmitted via the broadcast transmission network, such as, the radio (e.g., satellite or terrestrial) or the cable, etc. A tuning process and a detection process are treated on the frequency of a channel, which is designated with an instruction made by a user through a remote controller, etc. Also, the MPEG2-TS (transport stream), after being treated with a digital demodulation and an error correction process thereon, is outputted to a demultiplexing portion 1311, via a selector not shown in the figure, as an output thereof.

The separation/extracting portion 1311 separates/extracts a transport packet of a channel (e.g., a program), which is designated with the instruction made by the user through the remote controller, etc., from the MPEG2-TS. The transport packet being separated/extracted, in case when playing back the content, is further treated with separation/extraction of a PES (Packetized Elementary Stream) or an ES (Elementary Stream) of the video and the audio, to be outputted to a decoding portion 1312, and in case when recording the content, it is further added with the information of a time stamp, to be outputted to a content management portion 1304.

When playing back the content, the decoding portion 1312 takes out the PES or the ES of the video/audio to decode therein, and outputs the video/audio decoded are outputted to a display output portion 1303.

The display output portion 1303 outputs the video/audio decoded to an external display device 1220, via the digital and/or analog interface not shown in the figure. In this instance, an operation screen image to be presented to the user, such as, a menu or a list of contents, etc., which is generated in a drawing portion not shown in the figure, is composed on the video decoded, to be outputted.

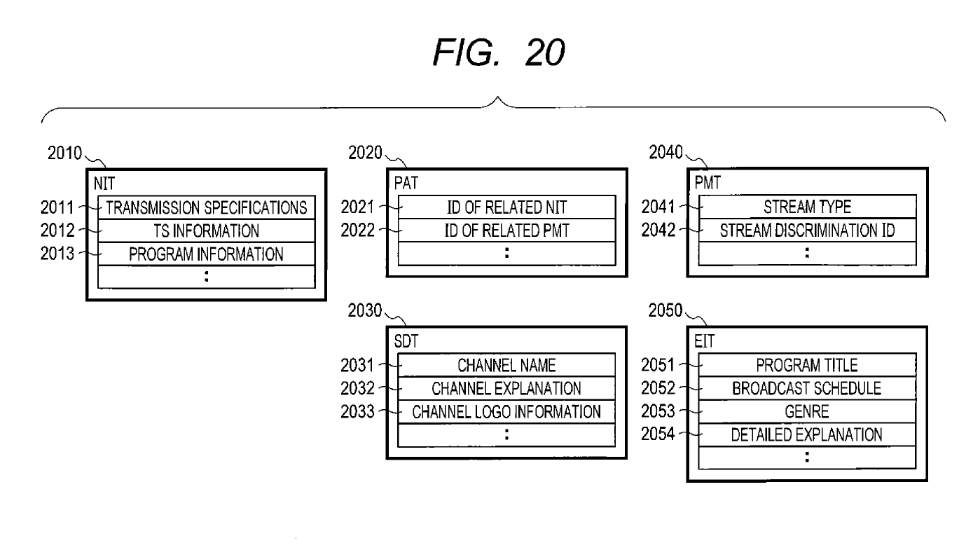

When recoding the content, the separation/extracting portion 1311 detects information, such as, a title and/or a genre of the channel (e.g., the program) to be recorded on a recording medium 1302, and/or format information, etc., from the transport packet of the channel (e.g., the program), which is designated with the instruction made by the user through the remote controller, etc., and outputs those to a content information managing portion 204. That information indicative of the title, the genre and/or a broadcasting schedule, etc., is to be stored in a PSI or an SI information of the MPEG-TS, for example (regarding explanation of an outline of the PSI and the SI information will be mentioned later, by referring to FIG. 20).

The content information managing portion 1304 produces management information upon basis of the information, such as, the title, etc., from the separation/extracting portion 1311, and also it conducts recording for the transport packet inputted from the separation/extracting portion 1311 on the recording medium 1302 upon basis of the management information mentioned above. In this instance, it is treated with an appropriate encoding process thereon, via an encoding portion not shown in the figure, to be recorded.

On the other hand, when transmitting the content recorded on the recording medium 1302 to the receiving apparatuses 1230 and 1240 on the home network 1200, firstly the transport packets of the content recorded on the recording medium 1302, which is designated with the instruction made by the user through the remote controller, etc., are read out successively, and those are outputted to a content transmitting portion 1306. In this instance, it is treated with the decoding of content thereon, through an encoding/decoding portion not shown in the figure, and is also treated with an encoding process thereon, to be outputted on the home network.

The content transmitting portion 1306 removes the time stamp information from the transport packet, which is decoded and added with the time stamp thereto, and outputs it to a network I/F portion 1308. The content transmitting portion 1306, other than this, receives a transmission start request and a transmission stop request of the content from the receiving apparatuses 1230 and 1240, through the network I/F 1308.

This request for transmitting the content is accepted as the parameters, each describing the position to start the transmission of content and/or the length thereof. When receiving this request, the transport packets) along the request is/are read out while executing a control, such as, a cue (search) designation or a length designation, appropriately, upon the content(s) recorded on the recording medium 1302, and is/are outputted to the network I/F portion 1308. On the other hand, when receiving the request for stopping the transmission, the output to the network I/F portion 1308 is stepped, and also the readout of the transport packet(s) from the recording medium 1302 is stopped.

The network I/F portion 1308 outputs the transport packet(s), which is/are inputted from the content transmitting portion 1306, to the receiving apparatuses 1230 and 1240, via the home network 1200, while executing a conversion into the format along a transmission regulation and a flow control thereon. The network I/F portion 1308 is also used, other than this, for example, in case when transmitting and/or receiving the information, such as, the chapter information or server device information, or service description information, etc., which will be mentioned later, to the receiving apparatuses 1230 and 1240 on the home network 1200.

The transmitting apparatus 1210 further includes a resume information calculating portion 1305 for calculating resume information indicating the position of interrupting the playback of content within the recording medium 1302, a server device information transmitting portion 1307 for transmitting the server device information attached with the information indicating that it has a resume information transmitting function, as well as, a control method thereof, and a resume information managing portion 1320 for managing the position of interrupting the playback of content within the recording medium 1302.

The resume information managing portion includes a resume information transmitting portion 1321 for transmitting the resume information to the receiving apparatuses 1230 and 1240, through the network I/F portion 1308, and a resume information receiving portion 1322 for receiving the resume information indicating the position of interrupting the playback of content within the receiving apparatuses 1230 and 1240.

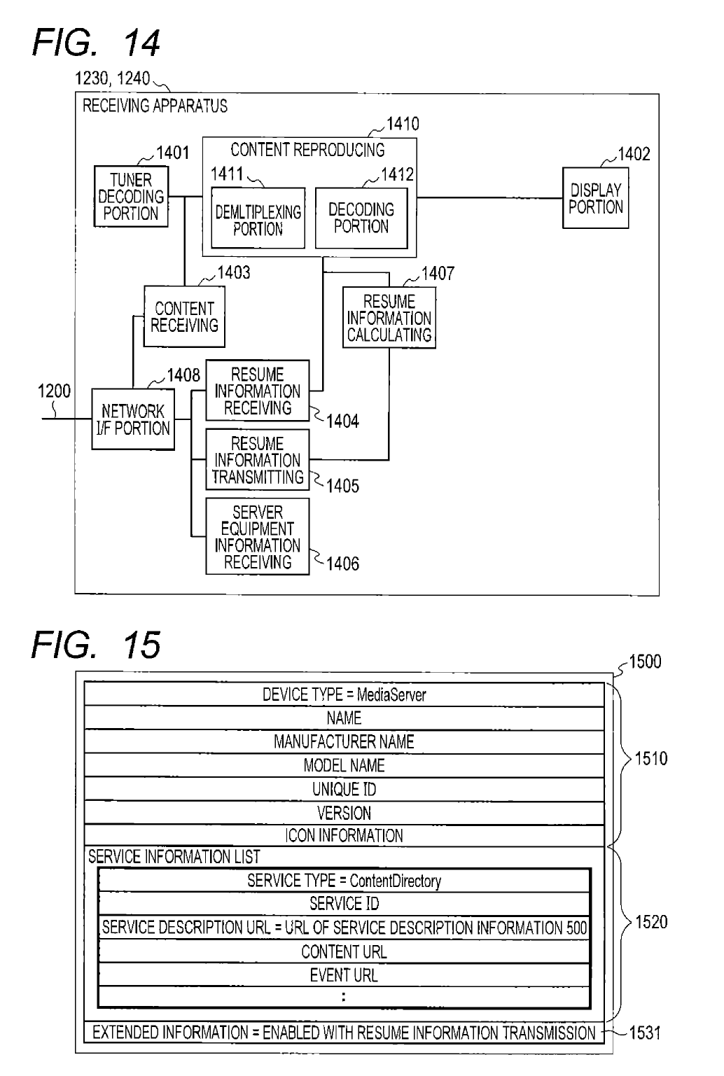

Next, explanation will be made on an example of the detailed structures of the receiving apparatuses 1230 and 1240, by referring to FIG. 14. Herein, explanation will be given by referring the receiving apparatus 1230 as an example.

The receiving apparatus 1230 is an apparatus for receiving the digital broadcast, and the content from the transmitting apparatus 1210 on the home network 1200, and for playing back the content therein.

When receiving and playing back the digital broadcast, a tuner decoding portion 1401 receives a digital broadcast signal, which is transmitted via a broadcast transmission network, such as, the radio (e.g., satellite or terrestrial) or a cable, etc. The tuner decoding portion 1401 treats the tuning process and the detection process on the frequency of the channel, which is designated with the instruction made by the user through the remote controller, etc. Also, it outputs the MPEG2-TS (transport stream) after being treated with the digital decoding and the error correction process thereon, to a demultiplexing portion 1411, via a selector not shown in the figure, as an output thereof.

The demultiplexing portion 1411 separates/extracts the transport packet of the channel (e.g., the program), which is designated with the instruction made by the user through the remote controller, etc., from the MPEG2-TS inputted. The transport packet, being separated/extracted, is further treated with the separation/extraction of the PES (Packetized Elementary Stream) or the ES (Elementary Stream) of the video and the audio, to be outputted to a decoding portion 1412.

On the other hand, when playing back the content, which is received from the transmitting apparatus 11 on the home network 1200, firstly it receives the transport packets of the content, which the transmitting apparatus 1210 transmits as a result of designation made by the user through the remote controller, successively, via a network I/F portion 1408.

The network I/F portion 1408 receives the transport packet to be outputted to a content receiving portion 1403 from the transmitting apparatus 1210, via the home network 1200, while executing the conversion from the format along the transmission regulation and the flow control thereon. The network I/F portion 1408 is also used, other than this, when transmitting and/or receiving the information, such as, the chapter information or the server device information, or the service description information, etc., which will be mentioned later, to/from the receiving apparatus 1210, etc., on the home network 1200.

The transport packet, being received through the network I/F portion 1408, is outputted to the content receiving portion 1403, and further, via a selector not shown in the figure, an output thereof is outputted to the demultiplexing portion 1411. In this instance, via the network transmission decoding portion not shown in the figure, decoding is executed on the content, which is encoded when being transmitted through the network I/F. The content receiving portion 1403, other than this, transmits a transmission start request and a transmission stop request, with adding the position for starting the transmission of content and the length thereof, as the parameters thereto, upon basis of instructions, such as, a cur (or search) playing back (e.g., chapter skip) or a fast-forward playback, or start/stop of an interruption (or a pause), etc., which is made by the user through the remote controller or the like, via the network I/F 1408, to the transmitting apparatus 1210.

The demultiplexing portion 1411 executes separation/extraction of the PES (Packetized Elementary Stream) or the ES (Elementary Stream) of the video and the audio, upon the transport packet, which is inputted from the content receiving portion 1403, to be outputted to the decoding portion 1412.

The decoding portion 1412 takes out the PES or the ES of the video/audio, to be decoded, and the video/audio decoded are outputted to a display portion 1402.

The display portion 1402 displays the video/audio decoded. In this instance, an operation screen image to be presented to the user, such as, a menu or a list of contents, etc., which is generated in a drawing portion not shown in the figure, is composed on the video decoded, thereby to be displayed.

The receiving apparatus 1230 includes a resume information calculating portion 1407 for calculating resume information indicating the position of interrupting playback of the content, which is received from the transmitting apparatus 1210 and played back therein, a server device information receiving portion 1406 for receiving the server device information attached with the information indicating that it has the resume information transmitting portion, and the service description information for indicating a control method thereof, through the network I/F 1408, a resume information receiving portion 1404 for receiving the resume information from the transmitting apparatus 1210, and a resume information transmitting portion 1405 for transmitting the resume information indicating the position of interrupting the playback of content.

Next, explanation will be given on an example of the server device information added with the information for indicating that it has the resume information transmitting function, by referring to FIG. 15. This is provided for the transmitting apparatus 1210 to make a transmission (or a turn back) responding to a request from the receiving apparatus 1230 or 1240, and is to be held within the server device information transmitting portion 1307, which was explained by referring to FIG. 13.

The server device information 1500 is constructed with, roughly, device information 1510 for indicating a type or a model of the device, and a service information list 1520 for indicating information of one or more numbers of services, which are provided by the device(s). The structure of this server device information 1500 of itself is not an unique one to the transmitting apparatus (e.g., the server), but depending on a value of the information to included herein, it is indicated that this is the transmitting apparatus (e.g., the server).

The device information 1510 is constructed with, as shown in the figure, a device type indicative of a type of the device, a name, a manufacturer name, a model name, a unique ID, version and icon information, etc., as the information of the device itself, which has the server device information 1500. And, in the case of the transmitting apparatus 1210, description that the device type is “Media Server” is made, as is shown in the figure, for the purpose of indicating that it is the transmitting apparatus (e.g., the server).

The service information list 1520 is constructed with, for example, a service type for indicating a type of the service, a service ID, a service description URL for indicating an accessing address to control details of that service, a control URL for indication a designation of control of that service, and an event URL for indicating a communication address of the service, etc., for each one (1) service, as the services to be provided by the device having that server device information 1500.

And, as is shown in the figure, in the present embodiment is applied a service for providing a content list, the service type of which is “Content Directory”, wherein the receiving apparatuses 1230 and 1240 can obtain the chapter information, for each content, with using the control method, which is described in the service description information 1600 (the details thereof will be mentioned later) for showing the control details of this service.

And, the information indicating to have the resume information transmitting function, according to the present invention, is described with using extended information 1531, other than the device information 1510 and the service information list 1520. With doing in this manner, even in the receiving apparatus not enabling the use of the resume information transmitting function, it is possible to interpret the device information 1510 and the service information list 1520 within the service device information 1500.

Also, a method can be considered, i.e., describing the information indicating to have the resume information transmitting function in the device information 1510 or the service information list 1520. In such case, various ways can be considered, for example, making such a presentation that the information indicating to have the resume information transmitting function is the information, which is extended in the device information 1510 or the service information list 1520, respectively, or making such description at the end thereof, etc.

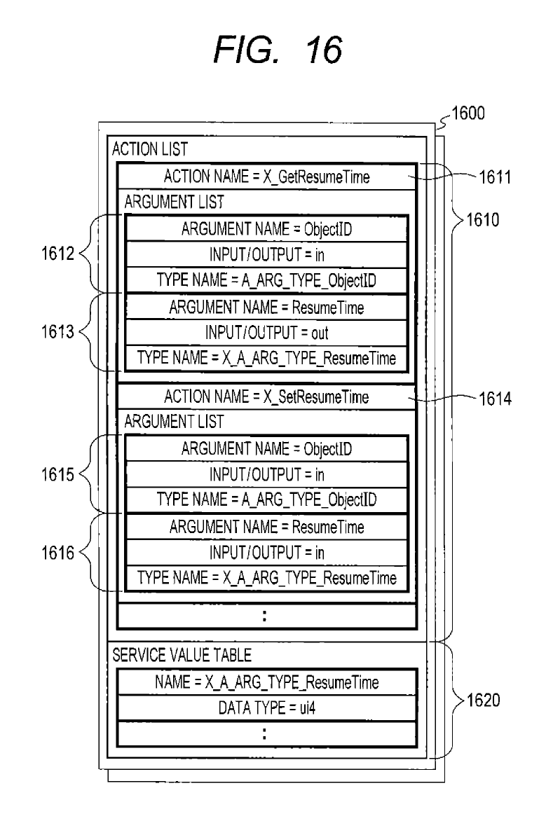

Next, explanation will be given on an example of the structures thereof, about the service description information 1600 for indicating the control details of the service, in the service for providing the content list, the above-mentioned service type of which is “Content Directory”, by referring to FIG. 16. This is transmitted (or returned) by the transmitting apparatus 1210 to a request from the receiving apparatus 1230 or 1240, and is held within the server device information transmitting portion 1307, which was explained by referring to FIG. 13.

The service description information 1600 is constructed with, roughly, an action list 1610 for indicating one (1) or more numbers of action (control) method(s) for that service, and a service value table 1620 for explaining a type of an input/output value of the action, which is described in the action list 1610, and those are prepared for each of the services.

In the action list 1610, as is shown in the figure, are described an action name and an argument list to be used in that action, for each action. In the argument list are described, an argument name, directions of input/output and a type name, for each argument. As an action in relation to obtaining and/or setup of the resume information, according to the present invention, can be defined that shown in FIG. 16.

The action indicated by the action name “X_GetChapterList” 1611 is for the transmitting apparatus 1210 to return the chapter information 1732, responding to the request from the receiving apparatus 1230 or 1240. In more details thereof, the receiving apparatus 1230 or 1240 makes a request, for obtaining the chapter information to the transmitting apparatus 1210, by designating the argument, which is shown in the argument 1612 (that having the argument name “ObjectID”).

And, the transmitting apparatus 1210, receiving this obtaining request, returns the resume information while setting up the argument shown in the argument 1613 (that having the argument name “ResumeTime”). However, the argument name “ObjectID” shown herein is an ID, for determining the content to be transmitted by the transmitting apparatus 1210, uniquely (details thereof will be mentioned later). Namely, it is an action, in which the transmitting apparatus 1210 returns the resume information corresponding to the content, which is designated from the receiving apparatus 1230 or 1240.

The action indicated by the action name “X_SetResumeTime” 1614 is for the transmitting apparatus 1210 to set up (renew) the resume information 1712 (will be mentioned later), responding a setup request from the receiving apparatus 1230 or 1240. In more details thereof, the receiving apparatus 1230 or 1240 makes a request for setting up the resume information to the transmitting apparatus 1210, by designating the arguments, which is shown in the argument 1615 (that having the argument name “ObjectID”) and the argument 1616 (that having the argument name “ResumeTime”).

And, the transmitting apparatus 1210, receiving this setup request, sets up (or renews) resume information 1712 (will be mentioned later) corresponding to the content, which is shown in “ObjectID” of the argument 1615, with using the “ResumeTime” shown in the argument 1616. Namely, it is an action, in which the resume information corresponding to the content, which is designated from the receiving apparatus 1230 or 1240.

The service value table 1620 is a table for explaining the type of the input/output value of the action, as was mentioned previously, on which, as is shown in the figure, are described a name (corresponding to the type name in the action list 1610) a data type of that type (a character string, a 4-bytes integer type having no mark, etc.), for each type.

In such actions “X_GetResumeTime” and “X_SetResumeTime” as was mentioned above, as is shown in the figure, since they use therein the type of name, such as, “X_A_ARG_TYPR_ResumeTime”, for example, description is made about that type (i.e., a data type of 4-bytes integer having no mark, such as, “ui4”, is described).

Namely, the argument “ResumeTime” is presented by a numerical value of the 4-bytes integer having no mark. Further mentioning about it, the present numerical value is for the purpose of presenting the resume position; however, since this is to be interpreted by the transmitting apparatus 1210 and the receiving apparatuses 1230 and 1240, mutually, a unit of that numerical value (i.e., a packet position and/or a time (seconds, milli-seconds, etc.)) is made unique, as the argument “ResumeTime” (for example, fixed to milli-seconds). In case of using other unit, there can be considered a method of changing the argument name to other name, or a method of presenting the unit by other argument, etc., for example.

character string (herein, it is assumed that the structure of the chapter information, which is presented by the character string, takes the structure of chapter information 1000, which will be mentioned later).

By referring to the server device information 1500 and the service description information 1600, which are shown in the above, it is possible for the receiving apparatuses 1230 and 1240 to obtain/set up the resume information. However, each of the names mentioned herein is used only for showing the example thereof, but should not be limited to the names described herein.

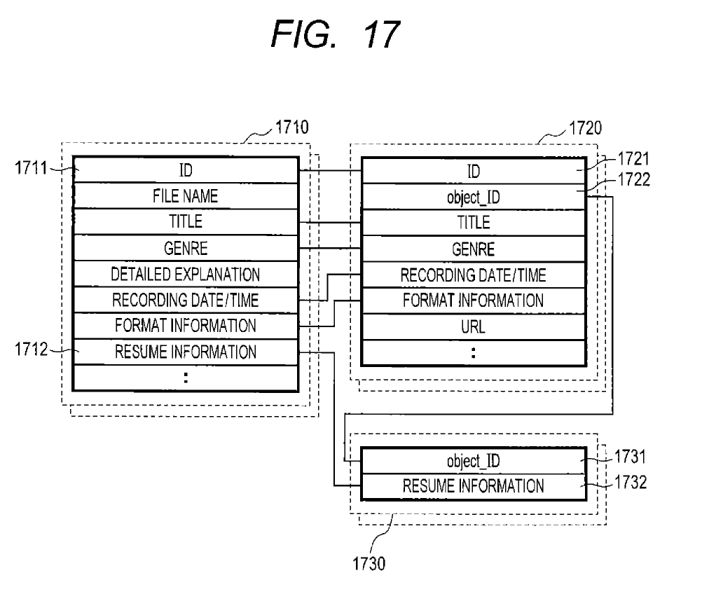

Next, explanation will be given on an example of the structures of a table for managing the content recorded on the recording medium 1302, the content to be transmitted to the receiving apparatuses 1230 and 1240, and the resume information for indicating the position of interrupting the playback of content, in the transmitting apparatus 1210, by referring to FIG. 17.

In FIG. 17, intra-recording medium content information 1710 is a table for managing the information of the content(s) recorded on the recording medium 1302, network distribution content information 1720 is a table for managing the content(s) to be transmitted to the receiving apparatus(es) 1230 and/or 1240, and resume information 1730 is a table for managing the resume information for indicating the position of interrupting the playback of content between the receiving apparatuses 1230 and 1240.

The intra-recording medium content information 1710 is constructed with, for example, an ID 1711 for determining the content, uniquely, and the resume information 1712 for indicating the position of interrupting the playback of content, and also other than those, a file name, a title, a genre, detailed explanation, recoding date/time, format informing, etc., wherein those are prepared for each content.

The resume information 1712 may differs from, in a method of expression thereof, depending on a kind or a recording format of the recording medium 1302. For example, it may be presented by a packet position or byte position from a top of the content. And, this intra-recording medium content information 1710 is to be held in the content information managing portion 1304 (or the recording medium 1302), which was explained by referring to FIG. 13.

The network distribution content information 1720 is constructed with, for example, an ID 1721 for determining the content uniquely, within the intra-recording medium content information 1710 (in this embodiment, taking the same value of an ID 1711), and an object_ID 1722 for determining the content, uniquely, to be transmitted to the receiving apparatuses 1230 and/or 1240, and also other than those, a title, a genre, recording date/time, content length, format information and URL, etc., wherein those are prepared for each of the contents.

However, although the title, the genre, the recording date/time and the format information are prepared, herein, inform of duplicating with the intra-recording medium content information 1710; however, those may not be prepared within the network distribution content information 1720, necessarily. In that instance, it is enough to read out the information corresponding to the intra-recording medium content information 1710 from the ID 1721. And, this network distribution content information 1720 is to be held in the content information managing portion 1304 (or the recording medium 1302), which was explained by referring to FIG. 13.

The resume information 1730 is constructed with, for example, an object_ID 1731, being an ID for determining the content, uniquely, within the network distribution content information 1720 (taking the same value to that of the ID 1711, in the present embodiment), and the resume information 1732 for indicating the position of interrupting the playback of content corresponding to that object_ID 1731. This resume information 1730 is to be in the content information managing portion 1304, which was explained by referring to FIG. 13.

Herein, explanation will be given about an outlook of the PSI and SI information, storing therein the title, the genre, the broadcasting schedule, etc., which are extracted by the transmitting apparatus 1210 when recoding the content and are held in the intra-recording medium content information 1710, by referring to FIG. 13.

The content multiplexed through MPEG-TS is transmitted, for example, in the broadcasting, in the form of one (1) or more number(s) of transport stream(s), in each frequency band region, converted through a frequency dividing method, etc. And, to each transport stream are multiplexed one (1) or more number(s) of content (a program), which is constructed with the video and the audio and data, to be transmitted.

In FIG. 20, on a NIT (Network Information Table) 2010 are stored, mainly, a transmission specification 2011 storing the frequency information for receiving a desired program from airwaves, TS (Transport Stream) information 2012, including a kind or sort of transmission of the transport stream corresponding to that transmission specification, and program information 2013, including the information of the channel number corresponding to that transmission specification, etc., and so on.

In PAT (Program Association Table) 2020 are stored an identification ID 2021 to the NIT 2010, which is included in that transport stream, and or an identification ID 2022 to PMT 2040, which will be mentioned later, for each channel (e.g., the program).

In SDT (Service Description Table) 2030 are stored a channel name 2031, a channel explanation 2032, and channel logo information 2033, such as, link information to logo data of the channel, etc., which are included in that transport stream, and so on, for each channel.

In PMT (Program Map Table) 2040 are stored a stream type 2041 (for identifying between a digital television service and a digital radio audio service, etc.), and a stream identification number 2042 for identifying actual data, into which that stream is stored, etc., for each stream.

In EIT (Event Information Table) 2050 are stored a program title 2051, a broadcasting schedule 2052 for showing start time/end time of the program, a genre 2053 for identifying a genre of the program, and a detailed explanation 2054 for showing explaining sentences of the program, etc., for each channel. And, on those tables are stored IDs, each for uniquely determining the transport stream, the channel and the program (not shown in the figure) corresponding thereto, respectively, and they are related with each other.

And, the transmitting apparatus 1210 extracts the title, the genre and/or the broadcasting schedule, etc., corresponding to the content (e.g., the program) to be recorded on the recording medium 1302, from those information, and holds them in the intra-recording medium content information 1710.

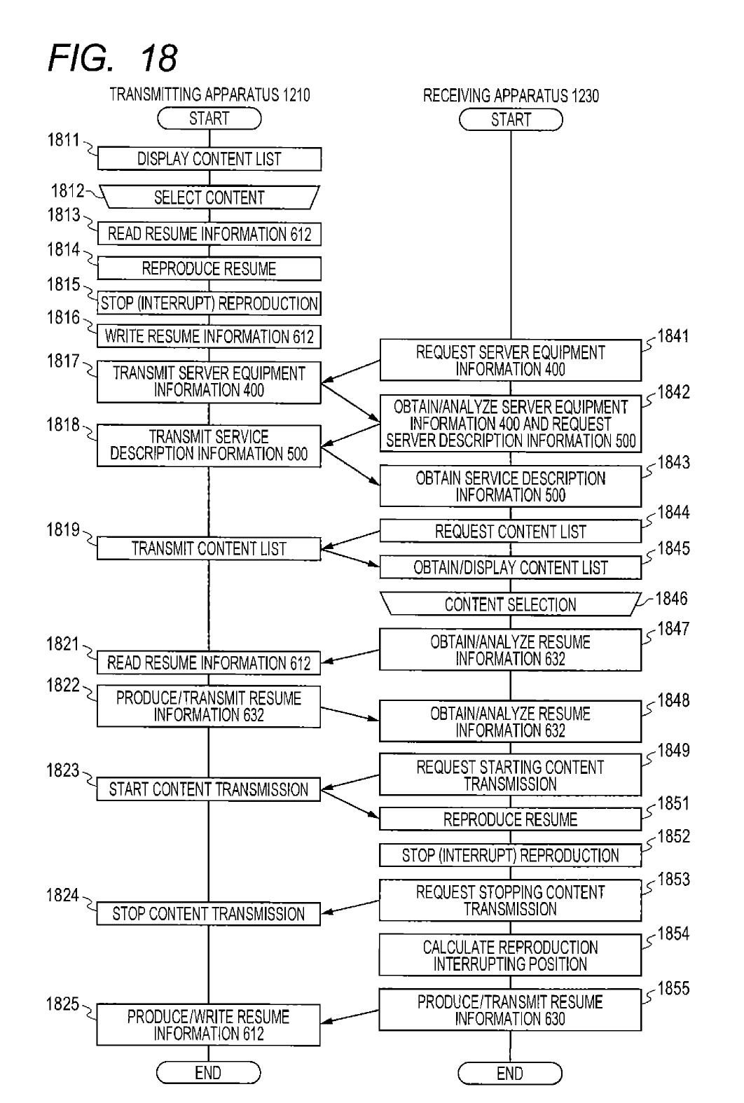

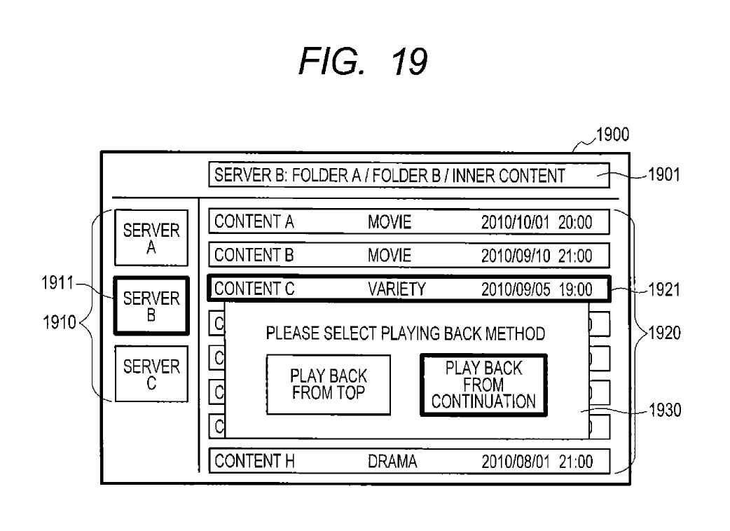

Next, explanation will be given on an example of a method for exchanging the chapter information between the transmitting apparatus 1210 and the receiving apparatus 1230 or 1240, in the home network 1200, with using the server device information 1500, the service description information 1600, the intra-recording medium content information 1710, the network distribution content information 1720, and the resume information 1730, by referring to FIG. 18 for showing a flowchart thereof and FIG. 19 for showing an operation screen to be presented to a user.

In the flowchart shown in FIG. 18, as a use case, there is listed up a case where, first of all, the content recorded on the recording medium 1302 of the transmitting apparatus 1210 is played back by the transmitting apparatus 1210 itself, and the playback thereof is stopped (or, interrupted), and thereafter, from the receiving apparatus 1230 (via the home network 1200), continuation of the content is played back (from the position of interrupting the playback), and finally, the playback thereof is stopped (or, interrupted).

First of all, within the transmitting apparatus 1210 is executed display of a content list (step 1811). In this step, the content information managing portion 1304 refers to the intra-recording medium content information 1710, and upon basis of this information, it generates an image drawn for the list display in the drawing portion not shown in the figure, and outputs it to external display device 1220 through the display output portion 1303.

Next, from the content list displayed, the user selects the content at her/his desire, and gives an instruction for playing back (step 1812). The transmitting apparatus 1210 receiving this instruction reads out the resume information 1712 of the content, which the user selects, by referring to the intra-recording medium content information 1710 (step 1813), and executes the playback of content through the content recording/playback portion 1310, by designating the position of interrupting the playback, which is described in that resume information 1712 (step 1814).

After viewing/listening of the content by the user, if she/he instructs to stop (or, interrupt) the playback thereof (this step is not shown in the figure), the transmitting apparatus 1210 stops the playback of that content (step 1851), and also calculates the position of interrupting the playback by means of the resume information calculating portion 1305; thereby renewing the resume information 1712 of that content (step 1816).

Then, next, on the receiving apparatus 1230, the user instructs an operation for displaying a list of contents, which are public on the home network 1200, for the purpose of executing the playback of the continuation of that content (this step is not shown in the figure).

The receiving apparatus 1230 upon receipt of this instruction, first of all, makes a request for the server device information 1500 to the device(s) on the home network 1200, through the server device information receiving portion 1406 (this request is executed also to the transmitting apparatus 1230) (step 1841). The transmitting apparatus 1210 receiving this request reads out the server device information 1500 through the server device information transmitting portion 1307, and transmits (or, turns back) this to the receiving apparatus 1230 (step 1817).

The receiving apparatus 1230 receives the server device information 1500 through the server device information receiving portion 1406, and requests the service description information 1600, while interpreting the structures described in the explanation given by referring to FIG. 15. Depending on the interpretation of resume information transmission response information 1531 made by this step 1842 within the server device information 1500, the receiving apparatus 1230 can see that the transmitting apparatus 1210 is enable with the function of transmission and/or setting up of the resume information.

And next, the transmitting apparatus 1210, receiving the request for the service description information 1600, reads out the service description information 1600 through the server device information transmitting portion 1307, and transmits (or, turns back) this to the receiving apparatus 1230 (step 1818).

The receiving apparatus 1230 receives the service description information 1600 through the server device information receiving portion 1406, and interprets the structures, which are described in the explanation given by referring to FIG. 16 (step 1843). Depending on the interpretation of the action list 1610 and the service value table 1620 made by this step 1843 within the service description information 1600, the receiving apparatus 1230 can know the method for executing the transmission and the setup of the resume information, with respect to the transmitting apparatus 1210.

Next, the receiving apparatus 1230 transmits the content list information for executing a list display of contents, to the transmitting apparatus 1210 (step 1844). This is executed upon basis of the method, which is described in the action list 1610 and the service value table 1620 within the service description information 1600.

The transmitting apparatus 1210 receiving the request of the content list information transmits (or, turns back) the information fitting to the request of the receiving apparatus 1230, by referring to the network distribution content information 1720 (step 1819). And, the receiving apparatus 1230 receives that content list information, and thereby executes the display of content list with using that information (step 1845). In this step, an image drawn for the list display is generated in the drawing portion not shown in the figure, and is outputted to the display portion 1402.

Next, the user selects the content at her/his desire from the content list displayed, and thereby gives an instruction for playback (step 1846). In this instance, such a selection screen 1900 is displayed, as is shown in FIG. 19, for example. In this FIG. 19, a reference numeral 1900 depicts a screen of the content list, and this screen is build up with, such as, a server (e.g., transmitting apparatus) displaying portion 1910 and a content list displaying portion 1920, roughly. The condition shown in this FIG. 19 indicates that a server B 1911 is selected as the transmitting apparatus, wherein a position content hierarchy is shown by 1901, which the server B 1911 opens to the public.

And, in that hierarchy, a content C 1921 indicates the information that is selected (or, instructed for playback). At time point of the step 1812, the content C 1921 is in the condition of being selected (or, instructed for playback), and at this time, as is shown by 1930, for example, a window is displayed for allowing selection, i.e., playing back that content C 1921 from a top or playing back it from the continuation thereof.

With doing in this manner, it is possible to instruct, not only the playback of content from the continuation, according to the present invention, but also the playback from ₜhe top thereof, easily. In case where the receiving apparatus 1230 memorizes the position of interrupting the playback of content by itself, it may be possible further to adopt that position to be selectable. However, in the explanation, which will be given hereinafter, explanation will be continued with an assumption that the user selects “playback from the continuation”.

The receiving apparatus 1230, upon receipt of “playback from the continuation”, next, through the resume information receiving portion thereof, (obtains) requests the resume information 1732 of that content to the transmitting apparatus 1210 (step 1847). This is executed in accordance with the method, which is described in the action list 1610 (with using the action name 1611 and the arguments 1612 and 1613).

And, the transmitting apparatus 1210, upon receipt of the (obtain) request of the resume information 1732, reads out the position of interrupting the playback, which is described in the resume information 1712 of the corresponding content, tracing back the network distribution content information 1720 and the intra-recording medium content information 1710, upon basis of the value of the ObjectID described in the argument 1612 (step 1821).

And, it generates the resume information 1732, by converting the value of the resume information 1712 into the form of the resume information 1732, depending on the necessity thereof, and it transmits (or, turns back) this to the receiving apparatus 1230 (step 1822). Next, the receiving apparatus 1230 receives that resume information 1732 through the resume information receiving portion 1406, so as to analyze the position of interrupting the playback (step 1848), and further requests the transmitting apparatus 1210 to start the transmission of content, with designating the position of interrupting the playback that is analyzed, through the content receiving portion 1403 (step 1849).

The transmitting apparatus 1210 execute the transmission of content data in accordance with the request for starting the transmission of content of the step 1849, through the content transmitting portion 1306 (step 1823), while the receiving apparatus 1230 receives that content data, successively, through the content receiving portion 1403, and thereby the playback of content is executed by means of the content playback portion 1410 (step 1851).

After viewing/listening of that content by the user, if she/he instructs the stopping (or, interruption) of playback thereof (this step is not shown in the figure), the receiving apparatus 1230 stops the playback of that content (step 1852), and also request the transmitting apparatus 1210 to step the transmission of that content (step 1853). And, the transmitting apparatus upon receipt of that request for stopping the transmission stops the transmission of that content (step 1824).

The receiving apparatus 1230, continuously, calculates the position of interrupting the playback through the resume information calculating portion 1407 (step 1854), thereby to generate the resume information 1730, and transmits it to the transmitting apparatus 1210 (step 1855). This is executed in accordance with the method, which is described in the action list 1610 (with using the action name 1614 and the arguments 1615 and 1616).

And, the transmitting apparatus 1210 receiving the (setup) request of the resume information 1730 generates the resume information 1712 of the corresponding content, upon basis of the value of the ResumeTime described in the argument 1616, while tracing back the network distribution content information 1720 and the intra-recording medium content information 1710, upon basis of the value of the ObjectID described in the argument 1615, and thereby writing it therein (step 1825).

With doing so as was mentioned above, in either case where the transmitting apparatus (i.e., the server) plays back the content by itself, or where the receiving apparatus (i.e., the client) receives the content within the server to play back it, the resume position can be obtained, mutually, and therefore it is possible to mage the resume position of content, uniquely, on the home network.

Also, the resume position where the client receives the content within the server, thereby to play back, since being calculated by the client itself, it is possible to manage the resume position of content, uniquely, on the home network.

Also, since the client is able to know if the server is enabled or not, with the function of providing the resume position information, there is no necessity of consciousness about the capability of this function, when interpreting the content list information. Namely, it is possible to guarantee the compatibility, with respect to the means for interpreting the content list information of the client(s), which is/are not enabled with this function. However, in the embodiment mentioned above, the explanation was given that the transmitting apparatus shown in FIG. 13 and the receiving apparatus shown in FIG. 14 have blocks 1301-1322 and blocks 1401-1412, respectively; however, each of the apparatuses may be structured, so that the functions that those blocks have and/or a function(s) not shown in the figure can be achieved by one (1) or plural numbers of CPU(s). For example, the blocks 1304, 1305, 1306, 1307, 1310 and 1320 in the transmitting apparatus 1210 have may be built up one (1) piece of CPU, so that the functions that they have can be achieved therewith.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A transmitting apparatus, comprising:
a playback portion, which is configured to playback content;
a content transmitting portion, which is configured to transmit said content through a network; and
a controlling portion, which is configured to hold chapter information for indicating separation of a scene of said content, and to transmit said chapter information held therein through said network, wherein
said controlling portion renews the chapter information held therein, when producing the chapter information, and when obtaining the chapter information, which is generated in other apparatus differing from said transmitting apparatus, through said network.

2. The transmitting apparatus, as described in the claim 1, wherein
said controlling portion transmits server device information indicating to have a function for transmitting content through said network, and
said server device information includes information indicating to have a function for transmitting said chapter information.

3. A receiving apparatus, comprising:
a content receiving portion, which is configured to receive content trough a network;
a playback portion, which is configured to play back said content; and
a controlling portion, which is configured to obtain chapter information for indicating separation of scene of said content, through said network, wherein
said controlling portion generates the chapter information of said content, and transmits said chapter information generated through said network.
when producing the chapter information, and when obtaining the chapter information, which is generated in other apparatus differing from said transmitting apparatus, through said network.

4. The transmitting apparatus, as described in the claim 3, wherein
said chapter information includes one or more number(s) of chapter list(s), each being constructed with one or more number(s) of chapter(s).

5. The transmitting apparatus, as described in the claim 3, wherein
said controlling portion obtains server device information for indicating a function of transmitting content through said network,
in said server device information is included information for indicating to have a function of transmitting said chapter information, and
obtains the chapter information for indicating the separation of scene of content through said network, or transmits the chapter information through said network, when said server device information indicates to have the function of transmitting said chapter information.

6. The transmitting apparatus, as described in the claim 4, wherein
said controlling portion obtains server device information for indicating a function of transmitting content through said network,
in said server device information is included information for indicating to have a function of transmitting said chapter information, and
obtains the chapter information for indicating the separation of scene of content through said network, or transmits the chapter information through said network, when said server device information indicates to have the function of transmitting said chapter information.

7. A transmitting apparatus, comprising:
a playback portion, which is configured to playback content;
a content transmitting portion, which is configured to transmit said content through a network; and
a resume information managing portion, which is configured to manage resume information for indication a position of interrupting playback of said content, wherein
said resume information managing portion renews the resume information to be managed in said resume information managing portion, when playback of said content by said playback portion is interrupted, and when obtaining the resume information for indicating the position of interrupting playback of content in other apparatus, through said network.

8. The transmitting apparatus, as described in the claim 7, wherein
the resume information to be managed in said resume information managing portion is transmitted through said network.

9. A receiving apparatus, comprising:
a content receiving portion, which is configured to receive content trough a network; and
a playback portion, which is configured to play back said content, wherein
when obtaining resume information for indicating a position for playing back said content through said network, said playback portion plays back said content from the position for playback, which is indicated by the resume information obtained, and when playback of said content in said playback portion is interrupted, the position of interrupting playback is calculated, and said resume information calculated is transmitted through said network.

10. The transmitting apparatus, as described in the claim 9, wherein
server device information relating to an origin of transmission of content through said network is obtained,
said server device information includes information for indicating to have a function of transmitting said resume information, and
when said server device information indicates to have the function of transmitting said resume information, obtaining of the resume information for indicating said portion for playback and transmission of the resume information for indicating the position where said playback is interrupted are executed.
